(19) United States
(12) Patent Application Publication
(10) Pub. No.: US 2025/0225435 A1
(43) Pub. Date: Jul. 10, 2025

(54) ARTIFICIAL INTELLIGENCE (AI) AND MACHINE LEARNING (ML) MODEL UPDATES

(71) Applicant: Telefonaktiebolaget LM Ericsson (publ), Stockholm (SE)

(72) Inventors: Daniel Chen Larsson, Lund (SE); Lars Lindbom, Karlstad (SE); Adrian Garcia Rodriguez, Paris (FR); Andres Reial, Höllviken (SE); Icaro Leonardo J. Da Silva, Solna (SE); Jingya Li, Göteborg (SE)

(21) Appl. No.: 18/850,694

(22) PCT Filed: Mar. 29, 2023
(86) PCT No.: PCT/IB2023/053131

§ 371 Date: Sep. 25, 2024

Related U.S. Application Data
(60) Provisional application No. 63/324,967, filed on Mar. 29, 2022.

(51) Int. Cl. G06N 20/00

(52) U.S. Cl. CPC G06N 20/00

(57) ABSTRACT

Disclosed are methods, apparatuses, and systems for using Artificial Intelligence (AI) and Machine Learning (ML) in cellular networks. In one aspect, a method is performed by a first node. The method includes sending, to a second node, a first message that indicates a request to update or reconfigure a functionality in the first node related to an ML-model or another functionality in which the ML-model is a part. The method further includes receiving, from the second node, a second message responsive to the first message, and performing an update of the functionality related to the ML-model based on the second message.

### CROSS-REFERENCE TO RELATED APPLICATIONS

This application claims the benefit of provisional patent application Ser. No. 63/324,967, filed Mar. 29, 2022, the disclosure of which is hereby incorporated herein by reference in its entirety.

### TECHNICAL FIELD

The present disclosure relates to methods, apparatuses, and systems for using Artificial Intelligence (AI) and Machine Learning (ML) in cellular networks.

### BACKGROUND

Artificial Intelligence (AI) and Machine Learning (ML) have been investigated, both in academia and industry, as promising tools to optimize the design of the air-interface in wireless communication networks. Example use cases include using autoencoders for Channel State Information (CSI) compression to reduce the feedback overhead and improve channel prediction accuracy; using deep neural networks for classifying Line-of-Sight (LOS) and Non-LOS (NLOS) conditions to enhance the positioning accuracy; and using reinforcement learning for beam selection at the network side and/or the User Equipment (UE) side to reduce the signaling overhead and beam alignment latency; using deep reinforcement learning to learn an optimal precoding policy for complex Multiple Input Multiple Output (MIMO) precoding problems.

In 3^{rd} Generation Partnership Project (3GPP) New Radio (NR) standardization work, AI/ML has been studied for the NR air interface. This study item explores the benefits of augmenting the air-interface with features enabling improved support of AI/ML based algorithms for enhanced performance and/or reduced complexity/overhead. Through studying a few selected use cases (CSI feedback, beam management, and positioning), this study item aims at laying the foundation for future air-interface use cases leveraging AI/ML techniques.

### SUMMARY

The present disclosure relates to methods, apparatuses, and systems for using Artificial Intelligence (AI) and Machine Learning (ML) in cellular networks. In one aspect, a method is performed by a first node. The method includes sending, to a second node, a first message that indicates a request to update or reconfigure a functionality in the first node related to a Machine Learning, ML, model or another functionality in which the ML-model is a part. The model further includes receiving, from the second node, a second message responsive to the first message, and performing an update of the functionality related to the ML-model based on the second message.

In some embodiments, the first message is a Radio Resource Control, RRC, message, Media Access Control, MAC, Control Element, CE message, a Msg1, a MsgA, a Msg3, a combination of Msg1 and Msg3, an Uplink Control Information (UCI), or a Sidelink Control Information, SCI. In some embodiments, the first message includes: (a) a request for a functionality update. (b) a functionality ID, (c) a functionality area ID characterizing a purpose of the functionality ID including a channel estimation, or a decoding., (d) an indication of whether the functionality can be updated in DRX, non-DRX, RRC_CONNECTED STATE, RRC_INACTIVE STATE or RRC_IDLE STATE, (e) a time required to update the functionality, (f) a preferred functionality at the second node. (g) an indication that indicates to the second node that the first node needs to update the ML-model, wherein the indication is transmitted within the first message including an RRC UEAssistanceInformation message, (h) a combination of any two or more of (a)-(g). In some embodiments, the method further includes receiving, from the second node, a second message responsive to the first message. In some embodiments, the second message is an RRC message, a MAC CE message, a Msg2, a MsgB, a Msg4, a PDCCH/PSCCH on a specific search space, a PDCCH/PSCCH addressed with a specific RNTI, a DCI format, or an SCI format. In some embodiments, the second message includes: (i) a functionality ID, (ii) a functionality area ID characterizing the purpose of the functionality ID, (iii) an indication of whether the functionality can be updated in DRX, non-DRX, RRC_CONNECTED STATE, RRC_INACTIVE STATE or RRC_IDLE STATE, (iv) a functionality executed at the second node, (v) another indication of whether the functionality of the first node is explicitly supported by the second node. (vi) a request for the first node to transmit more information about the functionality update and resources to use for such transmission, (vii) a location/time to update the functionality, (viii) an indication that indicates that the first node is to transition to IDLE or INACTIVE state, upon which the first node is to update or reconfigure the functionality, or (ix) a combination of any two or more of (i)-(viii)

In some embodiments, the method further includes sending, to the second node, a third message comprising an indication that the functionality related to the ML-model has been updated. In some embodiments, the third message is an RRC message, a MAC CE, Msg1, MsgA, Msg3, a combination of Msg1 and Msg3, UCI, or SCI. In some embodiments, the third message further comprises: (i) a functionality ID, (ii) a functionality area ID characterizing the technical functionality scope of the functionality, (iii) an indication on whether the functionality update is successfully completed, or (iv) a combination of any two or more of (i)-(iii). In some embodiments, the first message is a request message or an assistance information message. In some embodiments, the functionality is the ML-model or a functionality configured that is implemented in part by the ML-model. In some embodiments, the first node is a User Equipment, UE, and the second network node is a network node in a wireless network comprising a Radio Access Network (RAN) of a cellular communications system or a second UE.

In another aspect, another method is disclosed that is performed by a first node. The method includes performing an update of a functionality related to an ML-model without first sending a request to a second node; and sending, to the second node, a message comprising an indication that the functionality related to the ML-model has been updated.

In some embodiments, the message is an RRC message, a MAC CE message, a Msg1, a MsgA, a Msg3, a combination of Msg1 and Msg3, a UCI, or a SCI. In some embodiments, the message further includes (i) a functionality ID, (ii) a functionality area ID characterizing the technical functionality scope of the functionality, (iii) an indication on whether the functionality update is successfully completed, or (iv) a combination of any two or more of (i)-(iii). In some embodiments, the functionality is the ML-model or configured to be implemented in part by the ML-model. In some embodiments, the first node is a UE, and the second network node is a network node in a wireless network comprising a RAN of a cellular communications system or a second UE. In some embodiments, the method further includes providing user data; and forwarding the user data to a host via the transmission to the network node.

In another aspect, a method performed by a second node is disclosed. The method includes receiving, from a first node, a first message that indicates a request to update or reconfigure a functionality related to a Machine Learning, ML, model or another functionality in which the ML-model is a part. The method further includes sending, to the first node, a second message responsive to the first message, wherein the first node performs an update to the functionality related to the ML-model based on the second message.

In some embodiments, the first message is an RRC message, a MAC CE message, a Msg1, a MsgA, a Msg3, a combination of Msg1 and Msg3, a UCI, or a SCI. In some embodiments, the first message includes a request for a functionality update, (b) a functionality ID, (c) a functionality area ID characterizing the purpose of the functionality ID comprising a channel estimation or a decoding, (d) an indication of whether the functionality can be updated in DRX, non-DRX, RRC_CONNECTED STATE, RRC_INACTIVE STATE or RRC_IDLE STATE, (e) a time required to update the functionality, (f) a preferred functionality at the second node, (g) an indication that indicates to the second node that the first node needs to update an ML-model, wherein the indication is transmitted within the first message comprising an RRC UEAssistanceInformation message. (h) a combination of any two or more of (a)-(g). In some embodiments, the method further includes sending, to the first node, a second message responsive to the first message.

In some example embodiments, the second message is an RRC message, a MAC CE message, a Msg2, a MsgB, a Msg4, a Physical Downlink Control Channel, PDCCH/Physical Sidelink Control Channel, PSCCH, on a specific search space, a PDCCH/PSCCH addressed with a specific Radio Network Temporary Identifier (RNTI), a Downlink Control Information, DCI, format, or a Sidelink Control Information, SCI, format. In some embodiments, the second message includes (i) a functionality ID, (ii) a functionality area ID characterizing the purpose of the functionality ID, (iii) an indication of whether the functionality can be updated in DRX, non-DRX, RRC_CONNECTED STATE, RRC_INACTIVE STATE or RRC_IDLE STATE, (iv) a functionality executed at the second node, (v) an indication whether the functionality of the first node is explicitly supported by the second node, (vi) a request for the first node to transmit more information about the functionality update and the resources to use for such transmission, (vii) a location/time to update the functionality, (viii) an indication that indicates that the first node is to transition to IDLE or INACTIVE state, upon which the first node is to update or reconfigure the functionality, or (ix) a combination of any two or more of (i)-(viii). In some embodiments, the method further includes receiving, from the first node, third message comprising an indication that the functionality related to the ML-model has been updated. In some embodiments, the third message is an RRC message, a MAC CE message, a Msg1, a MsgA, a Msg3, a combination of Msg1 and Msg3, an UCI, or a SCI. In some embodiments, the third message further includes (i) a functionality ID, (ii) a functionality area ID characterizing the technical functionality scope of the functionality, (iii) an indication on whether the functionality update is successfully completed, or (iv) a combination of any two or more of (i)-(iii). In some embodiments, the first message is a request message or an assistance information message. In some embodiments, the functionality is the ML-model or implemented in part by the ML-model. In some embodiments, the first node is a UE, and the second network node is a network node in a wireless network comprising a RAN of a cellular communications system. In some embodiments, the method further includes obtaining user data; and forwarding the user data to a host or a user equipment.

Certain embodiments may provide one or more of the following technical advantages. Embodiments of the present disclosure may provide a clear picture for the network about when and what ML-model the network and the UE update, add, or depreciate, i.e., the ML-models supported at a given point in time. This may be done to ensure constant connectivity and a predictable behavior. This is particularly beneficial if the ML-models are updated/added/depreciated frequently or when the traffic is of a nature that connectivity cannot be lost.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows example block diagrams of a training pipeline and an inference pipeline and their interactions within a model lifecycle management procedure, in accordance with some example embodiments, in accordance with some embodiments.

FIG. 2 shows an example signal flow diagram between a UE and a network node where the UE requests to adjust a Machine Learning (ML)-model via a message, in accordance with some embodiments.

FIG. 3 shows another example signal flow diagram between a UE and a network node where the UE requests to adjust a ML-model via a message, in accordance with some embodiments.

FIG. 4 shows another example signal flow diagram where the UE sends to the network node a request for a ML-model adjustment occasions and the network configures the UE with ML-model adjustment time occasions, in accordance with some embodiments.

FIG. 5 shows an example signal flow diagram for a Radio Resource Control (RRC) based adjustment of a ML-model, in accordance with some embodiments.

FIG. 6 shows another example signal flow diagram for an RRC based adjustment of a ML-model, in accordance with some embodiments.

FIG. 7 shows an example of a Media Access Control (MAC) Control Element (CE) for requesting a ML-model update, in accordance with some example embodiments.

FIG. 8 shows another example of a MAC CE for requesting a ML-model update, in accordance with some example embodiments.

FIG. 9 shows an example of a MAC CE confirmation of a ML-model update, in accordance with some example embodiments.

FIG. 10 shows another example of a MAC CE confirmation of a ML-model update, in accordance with some example embodiments.

FIG. 11 shows yet another example of a MAC CE confirmation of a ML-model update, in accordance with some example embodiments.

FIG. 12 shows an example signal flow diagram of a UE initiating a random-access procedure by transmitting a Msg1 or MsgA to a network node, in accordance with some example embodiments.

FIG. 13 shows an example signal flow diagram where if no dedicated Msg1/MsgA resource is configured for indication a ML-model adjustment request, then the UE performs a Msg1/MsgA transmission using a contention-based random-access preamble, in accordance with some example embodiments.

FIG. 14 shows an example signal flow diagram where after the ML-model has been adjusted, the UE can initiate a random-access procedure to indicate to the network its successful completion of a ML-model adjustment by transmitting a Msg1 or MsgA to the network, in accordance with some example embodiments.

FIG. 15 shows an example signal flow diagram where if no dedicated Msg1/MsgA resource is configured for indicating a successful completion of a ML-model adjustment, then the UE transmits the indication of a successful completion of ML-model adjustment on the associated Msg3/MsgA Physical Uplink Shred Channel (PUSCH), in accordance with some example embodiments.

FIG. 16 shows an example of a communication system, in accordance with some example embodiments.

FIG. 17 shows a UE, in accordance with some embodiments.

FIG. 18 shows a network node, in accordance with some embodiments.

FIG. 19 is a block diagram of a host, in accordance with some embodiments.

FIG. 20 is a block diagram illustrating a virtualization environment, in accordance with some embodiments.

FIG. 21 shows a communication diagram of a host communicating via a network node with a UE over a partially wireless connection, in accordance with some embodiments

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

For ease of description, in the following, we consider that the first node is a User Equipment (UE) and the second node is a network node, referred to as ‘network’. However, as indicated in the previous section, some of the functionalities described below are understood to be applicable to other cases, e.g., those where the first node is a network node and the second node is a UE or where both the first and second nodes are UEs.

In the present disclosure, the terms “ML-model” (machine learning model) and “AI-model” (artificial intelligence model) are interchangeable. An Artificial Intelligence (AI)/Machine Learning (ML) model can be defined as a functionality or be part of a functionality that is deployed. implemented, or configured in a first node. This first node can receive a message from a second node indicating that the functionality is not performing correctly, e.g. prediction error is higher than a pre-defined value, error interval is not in acceptable levels, or prediction accuracy is lower than a pre-defined value. Further, an AI/ML-model can be defined as a feature or part of a feature that is implemented or supported in a first node. This first node can indicate the feature version to a second node. If the ML-model is updated, the feature version maybe changed by the first node.

An ML-model can be viewed as a functionality that is defined in a UE that can receive a message from a network indicate that the functionality is not performing correctly. Further the functionality is defined as a feature and that specific feature can have feature version that is indicated from the UE implementing the feature to a network that is communicated with the first node. If the functionality is updated the feature version maybe changed by the UE. The ML-model can be implemented by a neural network or other types of similar functions.

An ML-model may correspond to a function which receives one or more inputs (e.g., measurements) and provide as outcome one or more prediction(s) of a certain type. In one example, an ML-model may correspond to a function receiving as input the measurement of a reference signal at time instance t0 (e.g., transmitted in beam-X) and provide as outcome the prediction of the reference signal in timer t0+T. In another example, an ML-model may correspond to a function receiving as input the measurement of a reference signal X (e.g., transmitted in beam-x), such as a Synchronization Signal Block (SSB) whose index is ‘x’, and provide as outcome the prediction of other reference signals transmitted in different beams, e.g. reference signal Y (e.g., transmitted in beam-x), such as an SSB whose index is ‘x’. Another example is a ML-model for aid in CSI estimation, in such a setup the ML-model will be specific ML-model with a UE and an ML-model within the network side. Jointly both ML-models provide joint network. The function of the ML-model at the UE would be to compress a channel input and the function of the ML-model at the network side would be to decompress the received output from the UE. It is further possible to apply something similar for positioning wherein the input may be a channel impulse in some form related to a certain reference point in time. The purpose on the network side would be to detect different peaks within the impulse response that corresponds to different reception directions of radio signals at the UE side. For positioning, another way is to input multiple sets of measurements into an ML network and based on that derive an estimated positioning. Another ML-model would be an ML-model to be able to aid the UE in channel estimation or interference estimation for channel estimation. The channel estimation could for example be for the Physical Downlink Shared Channel (PDSCH) and be associated with specific set of reference signals patterns that are transmitted from the network to the UE. The ML-model will then be part of the receiver chain within the UE and may not be directly visible within the reference signal pattern as such that is configured/scheduled to be used between the network and UE. Another example of an ML-model for CSI estimation is to predict a suitable Channel Quality Indicator (CQI), Precoding Matrix Indicator (PMI), Rank Indicator (RI) or similar value into the future. The future may be a certain number of slots after the UE has performed the last measurement or targeting a specific slot in time within the future.

As discussed in the Background section above, in 3^{rd} Generation Partnership Project (3GPP) New Radio (NR) standardization work, AI/ML has been studied for the NR air interface. This study item explores the benefits of augmenting the air-interface with features enabling improved support of AI/ML based algorithms for enhanced performance and/or reduced complexity/overhead. Through studying a few selected use cases (CSI feedback, beam management, and positioning), this study item aims at laying the foundation for future air-interface use cases leveraging AI/ML techniques.

When applying AI/ML on air interface use cases, different levels of collaboration between network nodes and UEs can be considered:
No collaboration between network nodes and UEs. In this case, a proprietary ML-model operating with the existing standard air-interface is applied at one end of the communication chain (e.g., at the UE side), and the model life cycle management (e.g., model selection/training, model monitoring, model retraining, model update) is done at this node without inter-node assistance (e.g., assistance information provided by the network node).
Limited collaboration between network nodes and UEs. In this case, a ML-model is operating at one end of the communication chain (e.g., at the UE side), but this node gets assistance from the node(s) at the other end of the communication chain (e.g., a next generation Node B (gNB)) for its AI model life cycle management (e.g., for training/retraining the AI model, model update).
Joint ML operation between network notes and UEs. In this case, the AI model is split with one part located at the network side and the other part located at the UE side. Hence, the AI model requires joint training between the network and UE, and the AI model life cycle management involves both ends of a communication chain.

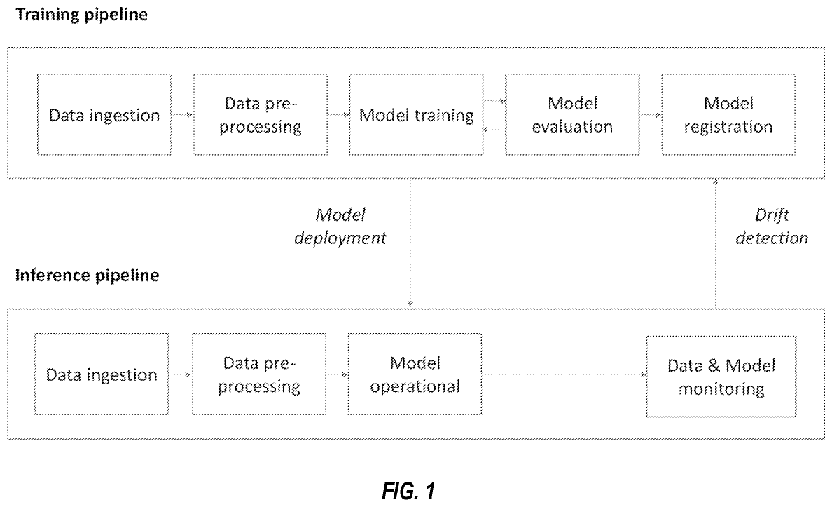

Building the AI model, or any machine learning model, includes several development steps where the actual training of the AI model is one step in a training pipeline. A part in AI development is the ML-model lifecycle management. This is illustrated in FIG. 1, which shows training and inference pipelines, and their interactions within a model lifecycle management procedure. The model lifecycle management typically consists of:
A training (re-training) pipeline that may include:
   Data Ingestion: Data ingestion refers to gathering raw (training) data from a data storage. After data ingestion, there may also be a step that controls the validity of the gathered data.
   Data Pre-Processing: Data pre-processing refers to some feature engineering applied to the gathered data, e.g., it may include data normalization and possibly a data transformation required for the input data to the AI model.
   Model Training: Model training refers to the actual model training steps as previously outlined.
   Model Evaluation: Model evaluation refers to benchmarking the performance to some model baseline. The iterative steps of model training and model evaluation continues until the acceptable level of performance (as previously exemplified) is achieved.
   Model Registration: Model registration refers to registering the AI model, including any corresponding AI-metadata that provides information on how the AI model was developed, and possibly AI model evaluations performance outcomes.
A deployment stage to make the trained (or re-trained) AI model part of the inference pipeline.
An inference pipeline that may include:
   Data Ingestion: Data ingestion refers to gathering raw (inference) data from a data storage.
   Data Pre-Processing: Data pre-processing stage is typically identical to corresponding processing that occurs in the training pipeline.
   Model Operational: Model operational refers to using the trained and deployed model in an operational mode.
   Data and Model Monitoring: Data & model monitoring refers to validating that the inference data are from a distribution that aligns well with the training data, as well as monitoring model outputs for detecting any performance, or operational, drifts.
A drift detection stage that informs about any drifts in the model operations.

There currently exist certain challenges. The area of handling ML-model updates within the 3GPP domain is a new area as such. This is true particularly when it involves both the UE and network. The solution to solve the specific problem would hence be that the UE and the network decide by themselves to update, add, or deprecate the ML-model whenever they want.

Consider the case where a UE needs to update an ML-model, introduce a new ML-model, and/or deprecate an ML-model. If the update/addition/deprecation is to be performed at any occasion in time, e.g. while the UE is in RRC_CONNECTED, this may cause a degradation in performance either for that specific UE or for the network, depending on which ML-model the UE is updating/adding/deprecating. Even in the case it happens while the UE is in RRC_IDLE or RRC_INACTIVE, it may affect idle/inactive procedures, e.g. paging monitoring disruptions may lead to a missed Paging, or the missed opportunity to resume or setup the connection if the UE has upcoming data to be transmitted, triggered by the application layer. For some ML-models, it will be so that during the actual update/addition/deprecation process the network cannot connect to the UE and hence it loses connectivity. Additionally, if the new active ML-model behaves differently, this may impact the network communication with the UE, e.g., if the new ML-model requires a change at the network side as well to perform adequately.

Certain aspects of the disclosure and their embodiments may provide solutions to these or other challenges. In one embodiment, a UE indicates to the network (e.g., to a network node) the need of performing an ML-model update and/or deprecation. The network sends another message to the UE, based on which the UE updates and/or depreciates its ML-model. In one embodiment, after this, the UE indicates that it has an updated ML-model for a certain functionality.

Some example embodiments of the present disclosure are as follows:
1. A method in a first node that is communicating with a second node, sending a message indicating a need of updating or reconfiguring a functionality (e.g., either the ML-model directly or the functionality that the ML-model is part of) to a second node, receiving a confirmation message to update the functionality from the second node,
2. A dependent embodiment to 1, sending an indication message that the functionality has been updated to the second node.
3. A dependent embodiment to 1, wherein the first node is a UE and a second node is network node.
4. A dependent embodiment to 1, wherein the message indicating the need of updating or reconfiguring a functionality (e.g., either the ML-model directly or the functionality that the ML-model is part of) is an RRC message, MAC CE, Msg1, MsgA, Msg3, a combination of Msg1 and Msg3, UCI, or SCI and includes/indicates at least one of the following information,
   request for a functionality update,
   a functionality ID,
   a functionality area ID characterizing the purpose of the functionality ID, e.g., channel estimation, decoding, etc.,
   if the functionality can be updated in DRX, non-DRX, RRC_CONNECTED STATE, RRC_INACTIVE STATE or RRC_IDLE STATE, time required to update the functionality,
   a preferred functionality at the second node,
   an indication indicating to the network that the UE needs to update an ML-model, wherein the indication is transmitted within the message (e.g., the RRC message UEAssistanceInformation).
5. A dependent embodiment to 1, wherein the confirmation message is an RRC message, MAC CE, Msg2, MsgB, Msg4, a PDCCH/PSCCH on a specific search space, a PDCCH/PSCCH addressed with a specific RNTI, a DCI format, or a SCI format, and the confirmation message includes at least one of the following information:
   a functionality ID,
   a functionality area ID characterizing the purpose of the functionality ID,
   if the functionality can be updated in DRX, non-DRX, RRC_CONNECTED STATE, RRC_INACTIVE STATE or RRC_IDLE STATE,
   a functionality executed at the second node,
   whether the functionality of the first node is explicitly supported by the second node,
   request for the first node to transmit more information about the functionality update and the resources to use for such transmission,
   location/time to update the functionality,
   an indication indicating that the UE shall transition to IDLE or INACTIVE state, upon which the UE updates the ML-model).
6. A dependent embodiment to 1, wherein the indication message is an RRC message, MAC CE, Msg1, MsgA, Msg3, a combination of Msg1 and Msg3, UCI, or SCI and includes at least one of the following information
   a functionality ID,
   a functionality area ID characterizing the technical functionality scope of the functionality,
   an indicate on whether the functionality update is successfully completed.
7. A dependent embodiment to 1, wherein the message is a request message or an assistance information message.
8. A dependent embodiment to 1, wherein the functionality is an ML-model alternatively it is functionality configured that is implemented in part by an ML-model.

That the functionality is in part defined by an ML-model can for example be seen by that it is possible to monitor/indicate the performance by of it by the network. It could also be so that it is directly defined in a specification that functionality can be supported with an ML based approach. Further below the word functionality is not used rather ML-model is used. The concept of ‘node in the above can be understood as a UE, a generic network node, gNB, base station, unit within the base station to handle at least some functionality, relay node, core network node, or a core network node that handle at least some ML operations.

The UE is connected to the network (e.g., it may receive and transmit data and/or control information). The UE may further be in RRC_CONNECTED state and being configured to use a specific function that is using an ML-model. The specific function can for example be for one of the following examples, later on this is referred to as functionality area:
CSI reporting
Beam management
Radio Resource Management (RRM) measurement
   Such as mobility measurement, i.e., Reference Signal Received Power (RSRP), Reference Signal Received Quality (RSRQ), Received Strength of Signal Indicator (RSSI), but also aspects related to radio link failure, e.g. Radio Link Failure (RLF) predictions.
   Such as the measurement framework defined in § 5.5., 3GPP Technical Specification (TS) 38.331 comprising how the UE perform measurements (e.g., measurement configuration), what triggers measurement reports (e.g., event-triggered reports, periodic reports), and content to be included in measurement reports).
   Hybrid Automatic Repeat Request (HARQ) transmission
   Data transmission
   Data reception
   Power control

The UE receiving a new software version comprises the UE performing the update of an existing ML-model, the reconfiguration of an existing ML-model (e.g., via Radio Resource Control (RRC) Reconfiguration), the introduction of a new ML-model, and/or the deprecation of an existing ML-model. In the following, the update/reconfiguration/addition/deprecation of the ML-model is referred to as an adjustment of the ML-model for ease of description. The adjusted ML-model may be executed to perform a function that currently being utilized by the network and/or the UE. The adjustment of the ML-model may affect the general connectivity for the UE to the network. As a result of the presence of an adjusted ML-model, the UE may include support for another ML-model or replace the ML-model currently active. To not disturb the network operation, the UE may wait to adjust the ML-model until the UE is in RRC_IDLE and/or RRC_INACTIVE state. In one option, while the UE is in RRC_IDLE or RRC_INACTIVE, the UE may adjust the ML-model in a time instance which does not overlap with a paging occasion configured by the network, i.e., when the UE does not have to monitor a possibly transmitted Paging message from the network, so that the UE remains reachable to the network and there is no disruption in case network wants to reach the UE. In another option, while the UE is in RRC_IDLE or RRC_INACTIVE, the UE may adjust the ML-model in a time instance in which the UE is not required to perform measurements for cell selection/re-selection evaluation, so that the adjustment of the ML-model does not degrade the cell selection/re-selection performance. In another option, while the UE is in RRC_IDLE or RRC_INACTIVE, the UE may adjust the ML-model in a time instance (e.g., one or more time slots, subframes, frames, specific adjustment occasions) configured by the network so that the network is aware that during these configured occasions the UE remains unreachable; one sub-option is to define a subset of the configured paging occasion(s) for that purpose.

The UE may also determine to adjust the ML-model based on the functionality associated to the ML-model and the current RRC state of the UE. For example, ML-model is associated to one or more functionalities to be performed in a first state, the UE waits until it enters a second state before it performs the adjustment. For example, if the ML-model is associated to an RRC_IDLE functionality (e.g., related to cell selection/reselection or paging), the UE waits until it enters RRC_CONNECTED to performs the adjustment.

When the UE goes into Discontinuous Reception (DRX), RRC_IDLE and/or RRC_INACTIVE state, the UE updates the software to adjust a ML-model. The update may also be performed while the UE is in non-DRX in RRC_CONNECTED, during non-monitoring intervals of Physical Downlink Control Channel (PDCCH) search space (SS). When the UE transitions to RRC_CONNECTED state (or when it is transitioning to RRC_CONNECTED, e.g. upon initiation of an RRC resume procedure or an RRC Setup/Establishment procedure) or non-DRX at some point later, the UE informs the network that it has adjusted its ML-model according to the update information. This may be done directly in a message indicating which ML-models have been adjusted. This may also be done by transmitting a random-access preamble to the NW to indicate that a ML-model has been adjusted, with more information about ML-model adjustment included in the following MsgA/Msg3 Physical Uplink Shared Channel (PUSCH) transmissions. In another embodiment, the UE may also indicate a preference for a model—not necessarily ML-based—to be executed at the network. Alternatively, the network may request a new ML-model or UE capability message, which may include a complete or partial complete list of the UE capabilities ML-model support from the UE, or it may request information about particular features only. The UE would then respond with UE capability information according to the request.

The UE may further adjust the ML-model(s) if the specific ML-model(s) is not configured or currently not in use but configured by the network. After the ML-model(s) are adjusted, the UE updates the network as described above.

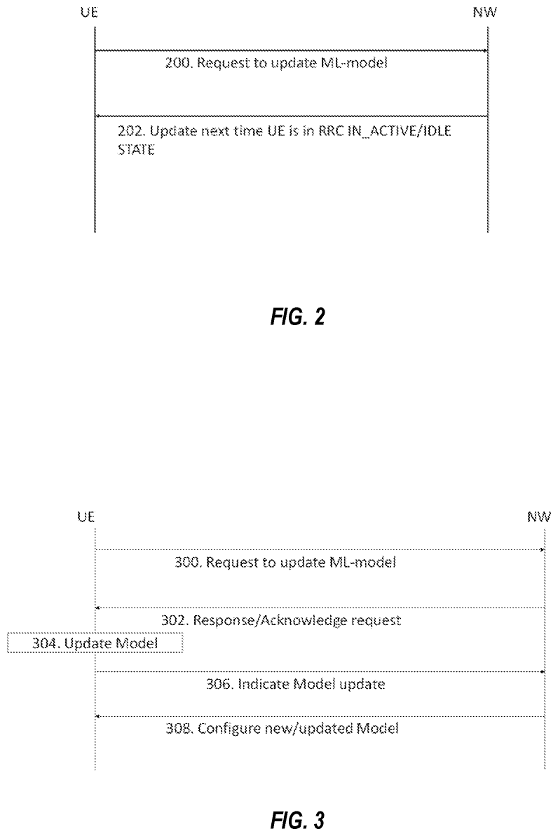

In another embodiment, as illustrated in FIGS. 2 and 3, the UE indicates to the network that it would like to adjust an ML-model via a message (step 200, step 300). The message can be an RRC message (e.g., UEAssistanceInformation), Medium Access Control (MAC) Control Element (CE), Msg1, MsgA, Msg3, a combination of Msg1 and Msg3 uplink control information (UCI) or another form of message. The message may not or may include which model is to be adjusted based on the support. The message may also contain a time required to perform the adjustment by the UE. The message may also indicate a preference for a model-not necessarily ML-based-to be executed at the network. In an example, after detecting the needs of ML-model adjustment, the UE initiates a random-access procedure by transmitting a Msg1 or MsgA to the network. A dedicated resources for Msg1/MsgA transmission (e.g., Physical Random Access Channel (PRACH) occasions, preamble indices) may or may not be configured for indicating a ML-model adjustment request. If no dedicated Msg1/MsgA resources are configured for indication a ML-model adjustment request, then, the request indication can be carried on the corresponding MsgA PUSCH or Msg3 PUSCH transmissions. More information about this ML-model adjustment can also be carried on the corresponding MsgA PUSCH or Msg3 PUSCH transmissions. In another example, after detecting the needs of ML-model adjustment, the UE sends to the network a MAC CE on its first available uplink shared channel (UL-SCH) resources for a new transmitting. The MAC CE carries the ML-model adjustment information. The MAC CE may or may not be a special MAC CE designed for ML-model adjustment, e.g., the legacy MAC CE for the associated functionality can be reused with modifications if needed. In yet another example, after detecting the needs of ML-model adjustment, the UE triggers a scheduling request (SR) for ML-model adjustment, and the SR can be sent on a PUCCH that is configured for indicating ML-model adjustment. More information about the ML-model adjustment can be carried on the scheduled PUSCH transmission(s).

In response to the message, the network may either order the UE to adjust the ML-model(s) or it may refuse the request from the UE (step 202, step 302). If the network refuses, the UE may perform the adjustment next time it goes to RRC_IDLE or RRC_INACTIVE state. The network may further just refuse the ML-model(s) to be adjusted based on not replying to the UEs message. The network may also indicate the model-not necessarily ML-based-to be executed at the network as a result of the UE adjustment. The response message can be an RRC message, MAC CE, Msg2, MsgB, Msg4, a PDCCH on a specific search space, a PDCCH addressed with a specific RNTI or a DCI format.

Another method for the network to order the UE to perform the ML-model adjustment is to send the UE to RRC_IDLE or RRC_INACTIVE state rather than sending a confirmation message to the UE. If, on the other hand, the network orders the UE to adjust the ML-model(s), that order may contain details on how and when the UE adjust the ML-model(s). The specific ML-model(s) may be identified with an ID. Note that it can be a subset of ML-model(s) that the UE requested to adjust. In addition, the order may contain a time-window wherein the ML-model(s) can be adjusted. The time window can give details on the system frame numbers (SFNs), subframes, slots or symbols when the adjustment can occur.

The UE updates the ML-model (step 304). The order of step 202 or 302 may contain a timer value, and upon reception the UE starts the timer; and while the timer is running the UE adjusts the ML-model and stops the timer after the model is adjusted; and if the timer expires (and the ML-model is not updated successfully) the UE declares a model update failure and triggers a re-establishment procedure (if security has been activated and the UE is in RRC_CONNECTED) or a transition to RRC_IDLE (if security has not been activated). It can further contain if the UE should adjust the ML-model in non-DRX, in DRX occasion, in RRC_INACTIVE or RRC_IDLE state. It could further be in specific occasions of DRX, RRC_INACTIVE or RRC_IDLE STATE.

Note: the terms RRC_IDLE and RRC_INACTIVE refers to RRC states as defined in 3GPP TS 38.300 for NR. However, the terms are applicable to any control plane (or RRC) states for which procedures are designed for power savings (e.g., cell selection/cell reselection, paging monitoring, etc.) rather than continuous data transmissions/receptions.

The UE may further adjust the ML-model in step 304 if it deems a configured DRX cycle as long enough presuming that the UE is going to DRX state. Hence another way for the network to order the UE to adjust the ML-model(s) in step 202 or 302 is to configure a long enough DRX cycle for the UE.

In another embodiment, the update in step 304 may also be performed while the UE is in non-DRX in RRC_CONNECTED, during non-monitoring intervals of the PDCCH SS. The UE may update the ML-model if it deems that a configured SS pattern includes non-monitoring durations that are long enough for model update. For SS patterns with off-durations on the order of, e.g., 10s to 100 ms, as may be configured in certain periodic, latency-sensitive traffic scenarios, the model weights may be updated in the ML execution environment without affecting the rest of the UE operation or requiring re-initialization.

In another embodiment, the update in step 304 may be performed during at least one autonomous gap. In one option, autonomous gap is used if the UE is configured by the network with an indication indicating that the UE is allowed to perform the update during autonomous gap. When the UE starts the autonomous gap for updating the ML-model, the UE also starts a timer Txxx (with a timer value which is hard-coded for this purpose or configured by the network) an performs the ML-model update while the timer is running. If the timer expires the UE stops using the autonomous gap and if the ML-model adjustment is successful, the procedure ends. If the timer expires and if the ML-model adjustment is not successful, the UE triggers a failure handling procedure, e.g. re-establishment (if security has been established) or transition to RRC_IDLE. In addition, if timer expires, one option is to notify the network that the procedure for updating the ML-model is not successful, so the network can take further actions, such as transition the UE to RRC_IDLE or RRC_INACTIVE (so the UE performs another attempt to adjust the ML-model).

If the ML-model(s) are in use and is adjusted at the same time, the UE may not be able to use the model while the adjustment is ongoing. During that time period, the UE may report a value out of range if the ML-model(s) are generating a report that is sent to the network as for example a CSI report, RSRP, RSRQ. RSSI reports. If instead the ML-model is for example a receiver functionality, the UE may fallback to another algorithm instead, either ML or non-ML based. Such an algorithm may have worse performance and hence the network may need to compensate for that. For example, if the UE is adjusting an ML-model for channel estimation, the non-ML based algorithm or the fall-back ML-model may require another reference signal pattern, for example a denser pattern. Hence the network would schedule with such a pattern during the period the model is being adjusted.

In one embodiment, if the ML-model is utilized for active data reception, the network may, after receiving the request message in step 200 or 300, provide a configuration to the UE that creates a safe window for model updating, based on at least the required duration of the update process provided in the request. For example, the NW may configure the UE with a DRX configuration that provides a sufficiently long off-duration, or it may configure an SS configuration with sufficiently long gaps between monitoring occasions.

In another embodiment, the network may not reconfigure the UE but it may indicate a scheduling gap to the UE, i.e. a commitment not to schedule the UE during a certain duration. The gap commitment may be implicit, implied from the confirmation message, where the duration is equal to the requested update time plus an optional offset. The commitment may be explicit, where the scheduling gap duration is included in the confirmation message.

In one embodiment, in these and other RRC_CONNECTED model update scenarios, the indication message from the UE in step 200 or 300 may be provided via UCI signaling, where the grant for PUCCH/PUSCH transmission may be provided by the network in the confirmation message. The granted resources may be timed to match the requested model update time by the UE, plus and optional margin/offset.

After the ML-model is adjusted, the UE may send a message indicating that the adjustment is completed (step 306). Such indication message can be an RRC message, an MAC CE, Msg1, MsgA, Msg3, a combination of Msg1 and Msg3 or UCI. In an example, after ML-model has been adjusted, the UE initiates a random-access procedure to transition from RRC_IDLE or RRC_INACTIVE state to RRC_CONNECTED state, by transmitting a Msg1 or MsgA to the NW. A dedicated resources for Msg1/MsgA transmission (e.g., PRACH occasions, preamble indices) may or may not be configured for indicating a successful completion of a ML-model adjustment. If no dedicated resources are configured for indication a successful completion of ML-model adjustment, then, the request indication can be carried on the corresponding MsgA PUSCH or Msg3 PUSCH transmissions. If needed, more information about this ML-model adjustment can carried on the corresponding MsgA PUSCH or Msg3 PUSCH transmissions. In another example, after the ML-model has been adjusted, the UE sends to the network a MAC CE on its first available UL-SCH resources for a new transmitting. The MAC CE carries the information to indication the network about the successful completion of the ML-model adjustment. The MAC CE may or may not be a special MAC CE designed for ML-model adjustment, e.g., the legacy MAC CE for the associated functionality can be reused with modifications if needed. In yet another example, an UCI in the form of an HARQ-ACK is send to the network for indicating the successful ML-model adjustment, and the HARQ-ACK can be sent on a PUCCH that is configured for indicating the successful completion of the ML-model adjustment. The indication message may indicate which ML-model has been successfully adjusted or it may be given based on the request by the network to adjust ML-model. Based on receiving the ML-model adjusted message, the network may reply to the UE with a confirmation message indicating that it has received the ML-model adjusted message and/or configure a new updated ML-model for the UE (step 308). After that, the UE may than active adjusted ML-model. Alternatively, the UE actives the adjusted ML-model directly after or close in time to it is adjusted or in connection to when ML-model adjustment message is sent. The in connection can be also related with a time delay after the adjustment complete message was sent by the UE.

Note that the same set of resources Msg1/MsgA transmission can be configured for indicating a ML-model adjustment request or indicating a successful completion of ML-model adjustment. In this case, whether it is indicating the ML-model adjustment request or indicating a successful completion of ML-model adjustment can be carried on the proceeding MsgA PUSCH or Msg3 PUSCH. Similarly, the same MAC CE can be used for indicating a ML-model adjustment request or indicating a successful completion of ML-model adjustment. And in this case, at least one bit in this MAC CE will be used for indicating whether this MAC CE is for ML-model adjustment request or for indicating a successful completion of ML-model adjustment.

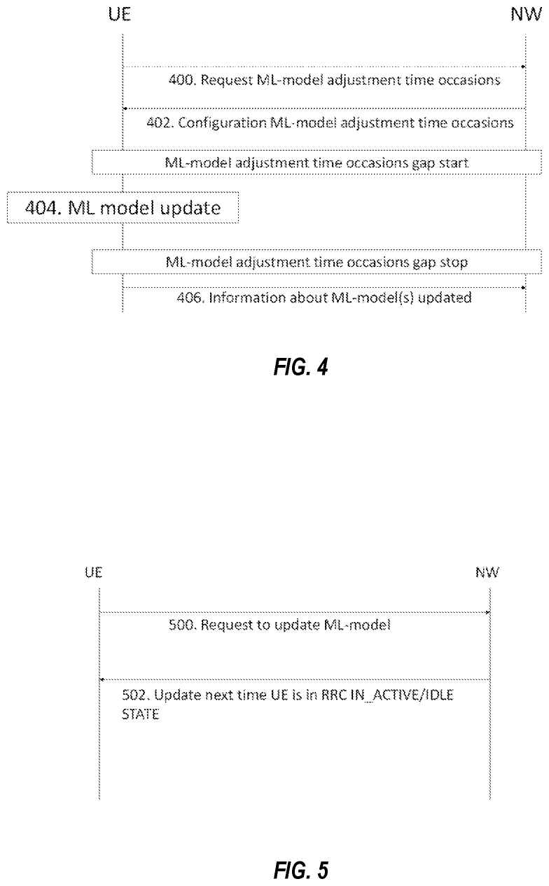

As illustrated in FIG. 4, in a different embodiment, the UE may send, to the network, a request for a ML-model adjustment occasion(s) (step 400), and the network configures the UE with ML-model adjustment time occasions (step 402). During such ML-model adjustment time occasions, the UE can adjust the ML-model if it wishes to do so (step 404). During an ML-model adjustment time occasions, the network cannot assume that the UE will respond to a scheduling message, since it may turn of functionality to adjust the ML-model. After the UE has adjusted the ML-model, it may communicate to the network details on the adjusted ML-models (step 406). The ML-model adjustment time occasions can be configured periodically by the network. Alternatively, the UE can request to be configured with an ML-model adjustment gap. If the network receives such a request, the network can then go ahead and configure an ML-model adjustment time occasions. The ML-model adjustment time occasions can be on time occasion, or it can be multiple occasions periodically or aperiodically occurring. Details around what the UE wants in this request can also be included in the ML-model adjustment time occasions request. There may further be different lengths of ML-model adjustment time occasions depending on how complicated it is for the UE to adjust the ML-model in question. The request may hence further include which length is preferred from the UE. Obliviously, the configuration of the ML-model adjustment time occasions from the network can include the length of the ML-model adjustment time occasions. The occasion in time of the ML-model adjustment time occasions is included in the configuration by the network and potentially with the length of the ML-model adjustment time occasions as mentioned.

The ML-model adjustment time occasions configuration can be an RRC, MAC CE or L1 message sent to the UE from the network. Each outlined information above can be combined or be separated fields in an RRC, MAC CE or L1 message for configuring an ML-model adjustment time occasions. The L1 message can for example be Downlink Control Information, DCI, format. The request of an ML-model adjustment gap message can be an RRC message, MAC CE or UCI information sent by the UE to the network. The information about the ML-model(s) adjusted from the UE to the network can be RRC, MAC CE or L1 message. That message can include ML-model ID that has been adjusted, the current ML-model version, the ML-model functionality area (see further below). The message can be sent by RRC, MAC CE or L1 signaling. If it is L1 signaling it can for example be an uplink control information.

In yet another embodiment, the UE will send a multicast-to at least a subset of the nodes communicating with the UE-or a broadcast message to signal the adjustment of an ML-model.

### 1. ML-Model Adjustment Based on RRC Based Update

As illustrated in the example embodiments of FIGS. 5 and 6, in a first example of an RRC based adjustment of the ML-model, the UE sends an RRC message (e.g., a request, or indication) to the network indicating that it wants or needs to adjust or update the ML-model (step 500, step 600). The message may further include which ML-model that is to be adjusted and the time required to adjust the model. In may also include information in which state the UE is able to adjust the model. These states could be for example within RRC CONNECTED STATE, RRC IN_ACTIVE STATE or RRC IDLE STATE. Further if the UE indicates that the adjustment can occur during RRC CONNECTED STATE, the UE may also indicate whether the adjustment can be performed during DRX or non-DRX periods. If the adjustment is indicated to occur during DRX, the UE may further indicate which type of DRX the adjustment can occur during, e.g., long or short DRX. The UE may report a UE capability to the network indicating how it is capable of updating an ML-model such as in RRC_IDLE state and/or in RRC_INACTIVE and/or RRC_CONNECTED and/or using autonomous gaps, which may be associated to a UE capability previously reported to the network. The information in which state the UE is able to adjust the model (e.g., RRC CONNECTED STATE, RRC IN_ACTIVE STATE or RRC IDLE STATE) may be associated to a UE capability which is reported as part of the UE capability signaling from the UE to the network, based on which the network determines.

In step 500 or step 602, the method comprises the UE indicating the need for adjustment of the ML-model during an RRC Procedure, such as one or more of the following:

### UE Assistance Information Procedure

The UE transmits a UEAssistanceInformation message including an indication of the need to adjust the ML-model, possibly including further information, e.g. functionality associated to the ML-model, like Beam Management, CSI report, and preferred configuration(s).
   In one option this may be in response to an RRC Reconfiguration indicating to the UE that the UE shall indicate the need to adjust the ML-model, when the UE needs to. In other words, the UEAssistanceInformation does not have to be transmitted by the UE shortly after the RRC Reconfiguration, but only when the UE needs to adjust the ML-model; thus, the RRC Reconfiguration is not a request message, neither the UEAssistanceInformation is a response, but the RRC Reconfiguration configures to UE to transmit the UEAssistanceInformation when it needs to adjust the ML-model. This procedure occurs when the UE is in a connected state (e.g., RRC_CONNECTED).

### UE Information Procedure

The UE receives a UE Information Request message from the network, including a specific request, requesting the UE whether the UE has an ML-model that needs to be adjusted. If the UE has an ML-model to adjust, the UE responds with a UE Information Response message indicating that the UE has an ML-model that needs to be executed.
   UE indicates the need adjust the ML-model in an RRC Setup Complete message;
The UE transmits a RRCSetupComplete message including an indication of the need to adjust the ML-model. As at this point the Access Stratum (AS) security is not activated, the UE does not include further information of the ML-model. This may be in response to reception of an RRCSetup message, wherein the RRCSetup message includes an indication that the UE shall include in the RRCSetupComplete message any need for updating the ML-model. This procedure occurs when the UE is in a connected state (e.g., RRC_CONNECTED).
   UE indicates the need in RRC Resume Complete message (secured message, ciphered and integrity protected, so UE may include further details about the update of the ML-model;
The UE transmits a RRCResumeComplete message including an indication of the need to adjust the ML-model. At this point the Access Stratum security is activated, so the UE may include further information of the ML-model that is to be adjusted, e.g. an indication of the parameters that are adjusted and/or functionalities associated, etc. This may be in response to reception of an RRCResume message, wherein the RRCResume message includes an indication that the UE shall include in the RRCResumeComplete message any need for updating the ML-model and further information about the adjustment.
   UE indicates the need in RRC Reconfiguration Complete;
The UE transmits a RRCReconfigurationComplete message including an indication of the need to adjust the ML-model. At this point the AS security is activated, so the UE may include further information of the ML-model that is to be adjusted, e.g. an indication of the parameters that are adjusted and/or functionalities associated, etc. This is transmitted in response to the reception of an RRC Reconfiguration message, wherein the RRC Reconfiguration message includes an indication that the UE shall include in the RRCReconfigurationComplete message any need for updating the ML-model and further information about the adjustment.
   UE indicates the need in a Measurement report;
The UE transmits a MeasurementReport message including an indication of the need to adjust the ML-model.
Upon reception of the MeasurementReport including the indication of the need to adjust the ML-model, if the source network node determines to handover the UE, e.g., based on content in the measurement reports, the source network node transmits the indication to the target network node (e.g., in the Handover Request, possibly within an RRC container) so that the target network node may indicate that the UE shall (or is allowed to) adjust the ML-model. In one option the UE is configured by the target in the handover command with configuration indication how it shall adjust the ML-model, e.g. an authorization to use an autonomous gap during some pre-determined about of time (or a configurable amount of time configured in the handover command).
In one option the UE adjust the ML-model during the handover, such as while timer T304 is running (started the timer when the UE applies the handover command, e.g., reconfiguration with sync). While the timer T304 is running the UE adjust the ML-model and after the model is adjusted, the UE transmits in the RRC Reconfiguration Complete message to the target network node, as part of the handover procedure, an indication that the ML-model has been successfully updated.
   UE indicates the need in a Reestablishment Complete message;
In one option, the UE transmits an RRC Reestablishment Request to the network (e.g., upon a Radio Link failure or any of the failures determines in TS 38.331 leading to a re-establishment procedure); receives in response an RRC Reestablishment message, and transmits an RRC Reestablishment Complete message including the indication that it needs;
   UE performs the ML-model adjustment during before a Reestablishment procedure;
In one option, the UE transmits an RRC Reestablishment Request to the network (e.g., upon a Radio Link failure or any of the failures determines in TS 38.331 leading to a re-establishment procedure); receives in response an RRC Reestablishment message, and transmits an RRC Reestablishment Complete message including the indication that it needs to adjust the ML-model;

In one option, upon the initiation of the RRC Re-establishment procedure the UE adjust the ML-model, taking the opportunity that it is performing cell selection while timer T311 is running (before the UE selects a cell and transmits the RRC Reestablishment Request message). In another embodiment, while in RRC_IDLE, the UE determines that it needs to adjust an ML-model and triggers an RRC Setup procedure, by transmitting an RRC Setup Request message.

In another embodiment, while in RRC_IDLE, the UE determines that it needs to adjust an ML-model and triggers an RRC Resume procedure, by transmitting an RRC Resume Request message (RRCResumeRequest or RRCResumeRequest1).

In another embodiment, while in RRC_CONNECTED, the UE determines that it needs to adjust an ML-model. The UE determines that based on the fact that it has downloaded (e.g., Over the top, from a server not necessarily placed at the network premises) an update of the ML-model, possibly including an indication of how critical it is to adjust the ML-model and/or how long the UE may wait until it adjusts the ML-model.

In another embodiment, while in RRC_CONNECTED, the UE determines that it needs to adjust an ML-model and transmits to the network an indication that it needs to transition to RRC_IDLE or RRC_INACTIVE (e.g., UE Assistance Information message), so that upon reception of an RRC Release message indicating the UE shall enter RRC_IDLE or RRC_INACTIVE, the UE adjust the ML-model upon entering the RRC_IDLE or RRC_INACTIVE state.

The information related to which model that is adjusted can be for a certain function on a higher level such as described above.

These can further be indicated as an ID rather the explicit naming of the functions. Another possibility is that the specific function or ML-model is directly indicated. This can be done for example either be explicitly indicating the corresponding RRC configuration that the gNB has configured the UE with that is applicable, ID of the model, etc. If it is the RRC configuration the UE may send specific RRC configuration message that is applicable to the gNB. If it is the ID of the model, this can be the ID of the model indicated within the UE capabilities, it can be an ID of the configuration assigned by the gNB to identify the particular configuration of ML-model or set of ML-models.

The network may respond to the message indicating which ML-model(s) the UE can adjust or just confirming directly that the indicated ML-model(s) can be adjusted (step 502, step 602). The network may further indicate during which time period the ML-model adjustment can occur, e.g. if it is during SS pattern including non-monitoring durations, non-DRX, DRX, RRC_INACTIVE, RRC_IDLE or any similar such state. The network may further indicate in the message more explicitly during which time the adjustment can start or occur, e.g., for example during which frame, SFN, subframes, slots, symbols and so on. FIG. 5 illustrates an example in which the adjustment can occur at the next time the UE is in RRC_IDLE or RRC_IN_ACTIVE STATE. FIG. 6 illustrates an example in which the adjust can occur in the next DRX occasion.

After the ML-model is adjusted, the UE may send a confirmation message indicating that the ML-model has been adjusted. That confirmation message can be an RRC message, MAC CE, or UCI message. The UCI message may in that case be HARQ-ACK. The MAC CE message details are further described in section 2.

Alternatively, the network can poll the UE for an adjustment of the ML-model and by that getting either the information about a specific ML-model or set of ML-model(s) and which specific version and if they are supported or not by the UE. Such a polling message can for example be an RRC message or a MAC CE. The UE will respond to such a message with the specific versions or version of the ML-model(s) that polled that are supported. The response message from the UE can be either a RRC message or an MAC CE.

### 2. ML-Model Adjustment Based on MAC CE Message

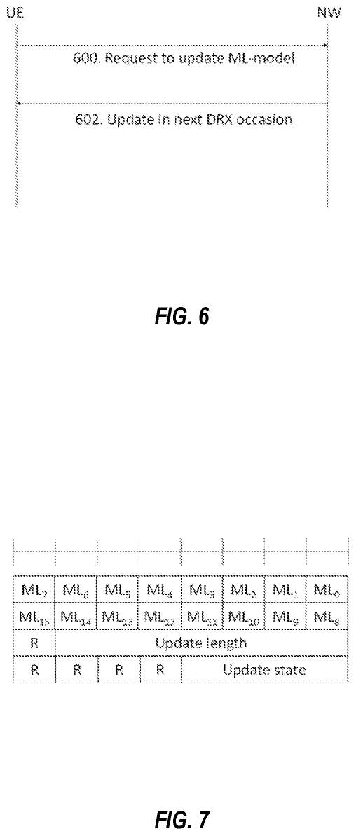

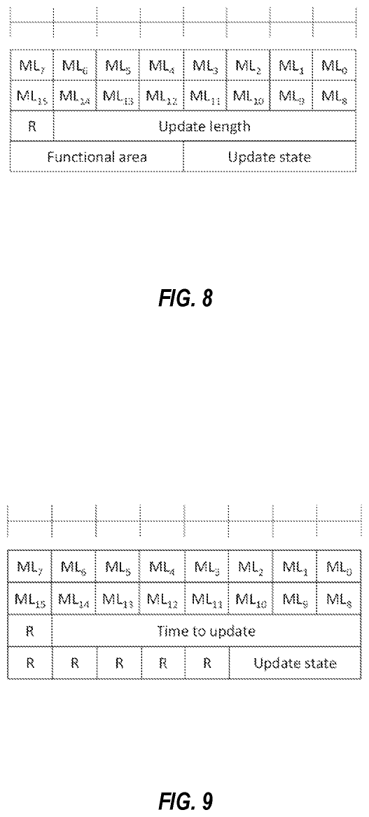

In a first example of an MAC CE based adjustment of the ML-model, the UE sends a request to the network to adjust the ML-model (e.g., in step 300 of FIG. 3). The request may further include which ML-model is to be adjusted and the time required to adjust the model. In may also include information in which state the UE is able to adjust the model. These states could be for example within RRC CONNECTED STATE, RRC IN_ACTIVE STATE or RRC IDLE STATE. Further if the UE indicate that the adjustment can occur during RRC CONNECTED STATE, the UE may indicate whether the adjustment can be performed during DRX or non-DRX periods. If the adjustment is indicated to occur during DRX, the UE may further indicate which type of DRX the adjustment can occur during, e.g. long or short DRX. The update could further also occur during SS pattern that includes non-monitoring durations and the signaling can indicate during which non-monitoring occasions of the SS pattern the adjustment can occur. An example of such a MAC CE is shown in FIG. 7 not including the MAC sub header.

FIG. 7 shows a MAC CE for requesting ML-model(s) update.

Within the MAC CE for requesting ML-model(s) to be adjusted in FIG. 7, the different fields represent the following:
MLᵢ: Is the ML-model ID that is requested to be adjusted. Each MLᵢ is a single bit. A specific value is used to indicate that the ML-model should be adjusted. If ML-model is not adjusted the other bit value is used. For example, the bit value ‘1’ may indicate that the ML-model is requested to be adjusted and then bit value ‘0’ implies that the ML-model should not be adjusted. Of course, the opposite is also possible in terms of bit values. Note that 16 number of ML-models is purely an example and the number of model IDs can be either smaller or larger, it can for example be 8, 32, 64, 128 and soon or any other value for that matter like.
Update length: This field give the amount of time needed to adjust the ML-model in some unit, for example SFNs, slots, symbols and soon. It may further give a recommended occasion in time.
Update state: This bit field indicates which state the adjustment could occur within. The field could be a bit map wherein each bit represents the state the UE can adjust the model. Or it can be a bit field and indicate the lowest state or only state. If it is the lowest state there could be some form of priority list. The state to illustrate with can be SS pattern including non-monitoring durations. non-DRX, DRX, RRC_INACTIVE or RRC_IDLE. If it is a priority list and DRX is indicated the network can then assume that everything after DRX in the list is also possible for the UE to adjust the ML-model within. If on other hand the field is a bit map each bit may directly represent each of this state. Note that there could be more states than this. One can for example split apart DRX into short and long DRX, wherein each of these DRX part governs how long the DRX cycle can be. See TS 38.321 V16.6.0 for more details. Further it may be possible to split apart different DRX cycle lengths.
R: is reserved bit to keep the message being of octet alignment.

Note further that not all fields maybe present either. In addition, as shown in the example in FIG. 8, an additional field of functionality area is added. This field indicates which are the ML-model is within. A functionality area can for example any of the listed topics described above. The merit with this is that the number of indicated ML-models may not need to spread the whole UE but can be divided in the functionality areas. Each ML-model is then associated with functionality area. The functionality areas could also be purely configured by the network as different association. In another example, the type of this MAC CE or the functionality area is indicated by defining new values in the eLCID field for UL_SCH.

FIG. 8 shows a second example of an MAC CE for requesting ML-model(s) update.

The network can reply to the ML-model adjustment request message with either a MAC CE message or an L1 message (step in step 302 of FIG. 3). The L1 message is further described under section 3. The networks MAC CE message can contain similar aspects as described at the beginning of the description above and in section 1 above. An example of such a MAC CE without the MAC sub header is shown in FIG. 9.

FIG. 9 shows MAC CE confirmation of ML-model(s) update

Within the MAC CE for confirmation ML-model(s) to be adjusted in FIG. 9 the different fields represent the following:
MLᵢ: Is the ML-model ID that is confirmed can be adjusted. Each MLᵢ is a single bit. A specific value is used to indicate that the ML-model should adjusted. If ML-model is not adjusted the other bit value is used. For example, the bit value ‘1’ may indicate that the ML-model is requested to be adjusted and then bit value ‘0’ implies that the ML-model should not be adjusted. Of course, the opposite is also possible in terms of bit values. Note that 16 number of ML-models is purely an example and the number of model IDs can be either smaller or larger, it can for example be 8, 32, 64, 128 and soon or any other value for that matter like.
Time to update: This field gives when in time the ML-model can be adjusted, e.g., SFNs, slots, symbols and so on. Alternatively, it can give which occasion of the ML-model should adjusted, i.e. the next DRX occasion or second to next and soon.
Update state: This bit field indicates which state the adjustment could occur within. The field could be a bit map wherein each bit represents the state the UE can adjust the model. Or it can be a bit field and indicate the lowest state or only state. If it is the lowest state, there could be some form of priority list. The state to illustrate with can be SS pattern including non-monitoring durations, non-DRX, DRX, RRC_INACTIVE or RRC_IDLE. If it is a priority list and DRX is indicated, the network can then assume that everything after DRX in the list is also possible for the UE to adjust the ML-model within. If, on other hand, the field is a bit map, each bit may directly represent each of these states. Note that there could be more states than this. One can for example split apart DRX into short and long DRX, wherein each of these DRX part governs how long the DRX cycle can be. See TS 38.321 V16.6.0 for more details. Further it may be possible to split apart different DRX cycle lengths.
R: is reserved bit to keep the message being of octet alignment.

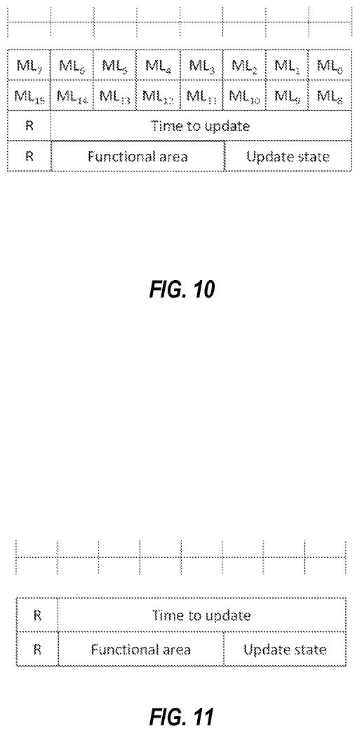

Further even functionality area can be added to the MAC CE as within the request MAC CE, as illustrated in the example of FIG. 10. In another example, the type of this MAC CE or the functionality area is indicated by defining new values in the eLCID field for DL-SCH.

FIG. 10 shows an additional example of MAC CE confirmation of ML-model(s) update.

In yet another example, the ML-model IDs are not included in the MAC CE confirmation of ML-model(s), as illustrated in the example of FIG. 11. Instead, the UE assumes that it can adjust the ML-model(s) if it receives such a message from the network. The structure of such a message is illustrated in FIG. 11.

FIG. 11 shows yet an Additional example of MAC CE confirmation of ML-model(s) update.

In yet another example, the type of this MAC CE or the functionality area is indicated by defining new values in the eLCID field for DL_SCH.

### 3. ML-Model Adjustment Based on UCI Update

In yet another example, the UE may send a UCI message indicating that it needs to adjust a specific ML-model or any ML-model (e.g., in step 300 of FIG. 3). This can for example be configured by a periodic report that is setup with a certain periodicity. If it is any model, the UE can send a single bit that indicates that it needs to adjust some ML-model. As an example, this single bit can be represented by a scheduling request (SR) transmitted on a PUCCH configured for ML-model request or on a PUCCH configured for the associated functionality. The network can then send a request asking which ML-model the UE wants to adjust or, alternatively, respond allowing or not an adjustment of the ML-model without knowing which ML-model is being updated (e.g., in step 302 of FIG. 3). As an example, this additional information asked by NW can be carried on the PUSCH that is scheduled by the NW after receiving the SR from the UE. If the UCI message is multiple bits, the bit field can directly indicate which ML-model that is supposed to be adjusted. The UCI information may be sent on PUCCH or PUSCH or any other type of physical layer channel. The network response message can be sent on Downlink Control Information, DCI, format. This DCI format being a specific format, transmitted in a specific search space, or addressed with a specific RNTI indicating that it is a response message to allow the UE to adjust its ML-model(s). After the UE has adjusted the ML-model(s) the UE may respond with an HARQ-ACK message, in principle an Acknowledgement that the adjustment has been performed and is successful.

### 4. ML-Model Adjustment Based on Random Access Procedures

### 4.1 Random Access Procedure for Enabling a UE to Request Performing its ML-Model Adjustment and Obtain Response from the NW

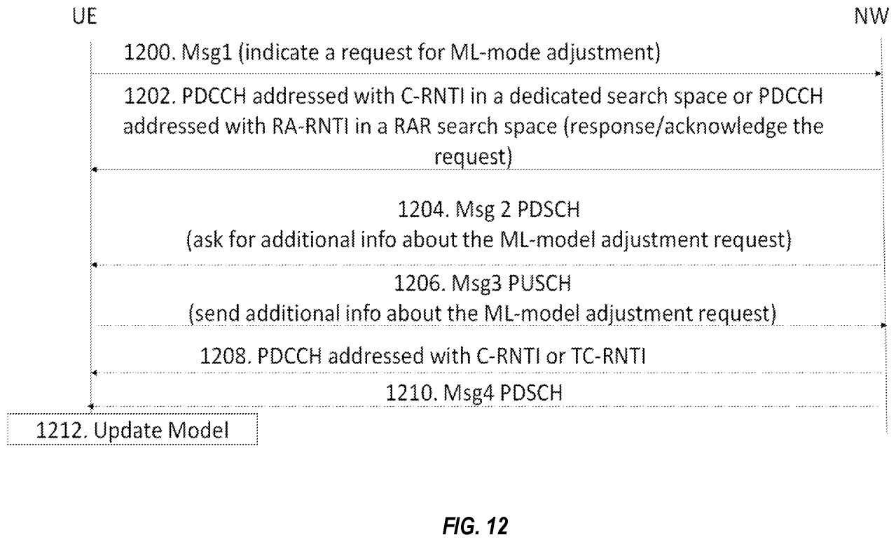

As illustrated in FIG. 12, in an example, after detecting the needs of ML-model adjustment, the UE initiates a random-access procedure by transmitting a Msg1 or MsgA to the network (step 1200). A dedicated set of RACH resources may or may not be configured for indicating a ML-model adjustment request.

Assume that dedicated Msg1/MsgA resources (e.g., PRACH occasions, preamble indices) are configured for indication a ML-model adjustment request, the network can receive the ML-model adjustment request by detecting the Msg1/MsgA transmitted from the UE. Then, the network can either respond to the request by sending a PDCCH addressed with C-RNTI in a dedicated search space or respond to the request by sending a PDCCH addressed with RA-RNTI in a random-access response (RAR) search space (step 1202). The UE monitors this PDCCH within a RAR window. The search space or/and RAR window may or may not be specifically configured for ML-model adjustment. If the UE receives this PDCCH within the RAR window, then, the UE considers the network successfully received its request for ML-model adjustment.

If no additional information is required from the network, the UE can either perform ML-Model adjustment directly, or it can be instructed by the network to firstly go to the RRC_IDLE RRC_INACTIVE state and then performs ML-Model adjustment. If additional information is required by the network, then, the network may use the PDCCH to schedule a Msg2 PDSCH, which carries information on what additional information about this ML-model adjustment the UE should provide to the network, and an UL grant to schedule the UE to transmit the additional information on a Msg3 PUSCH (step 1204). After decoding this Msg2 PDSCH, the UE transmits additional information on the scheduled Msg3 PUSCH (step 1206). The UE receives an ACK from the network on Msg4 (step 1206). Then, the UE can either perform ML-model adjustment directly, or it can be instructed by the network to firstly to go to the RRC_INACTIVE Mode and then performs ML-Model adjustment.

Thus, FIG. 12 illustrates an example of using random access procedure for enabling a UE to request performing its ML-model adjustment and obtain a response from the NW, assuming that a set of dedicated Msg1/MsgA resources is configured for ML-model adjustment. The dashed lines represent the optional signaling between the UE and the NW.

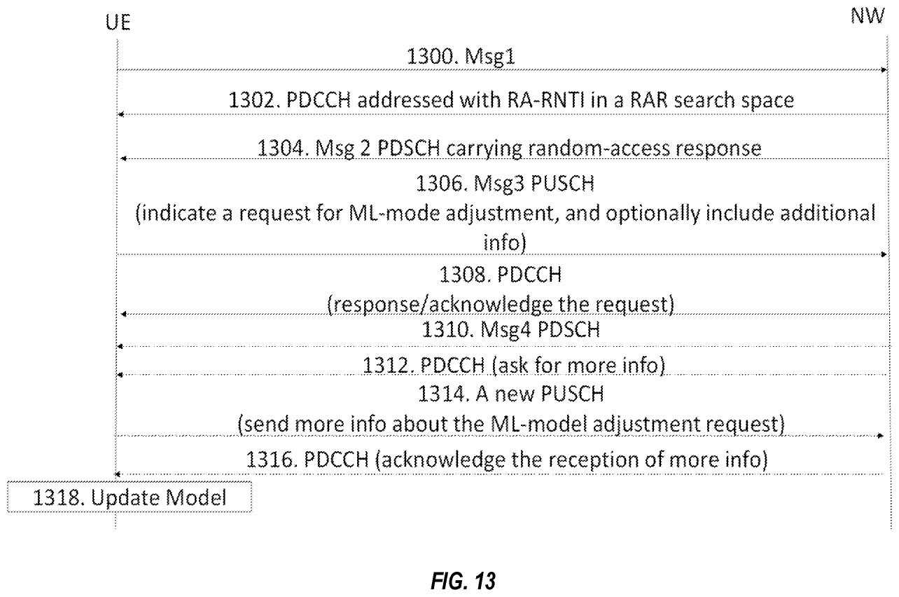

As illustrated in the example of FIG. 13, if no dedicated Msg1/MsgA resource (e.g., PRACH occasions, preamble indices) is configured for indication a ML-model adjustment request, then, the UE may perform Msg1/MsgA transmission using a contention-based random-access preamble (step 1300). The network may respond with a PDCCH addressed with the RA-RNTI in a RAR search space (step 1302) and a Msg2 PDSCH carrying a RAR (step 1304). The UE transmits the ML-model adjustment request related information on the associated Msg3/MsgA PUSCH (step 1306). This can be enabled by e.g., defining a new RRC establishment cause or/and a new RRC resume cause for indicating the ML-model adjustment request, or adding new parameters in Msg3/MsgA for indicating the ML-model adjustment request. If the UE successfully detect the Msg4/MsgB (step 1308), then it considers that the network has received its request for ML-model adjustment. If no additional information is required from the network, the UE can either perform ML-Model adjustment directly, or it can be instructed by the network to firstly go to the RRC_IDLE RRC_INACTIVE state and then performs ML-Model adjustment. Otherwise, the network can schedule a new PUSCH transmission and asks the UE to send additional information to the network (steps 1312-1316).

Thus, FIG. 13 illustrates an example of using random access procedure for enabling a UE to request performing its ML-model adjustment and obtain a response from the NW, assuming that no dedicated Msg1/MsgA resources is configured for ML-model adjustment. The dashed lines represent the optional signaling between the UE and the NW.

### 4.2 Random Access Procedure for Enabling a UE to Indicate a Successful Completion of its ML-Model Adjustment to the NW

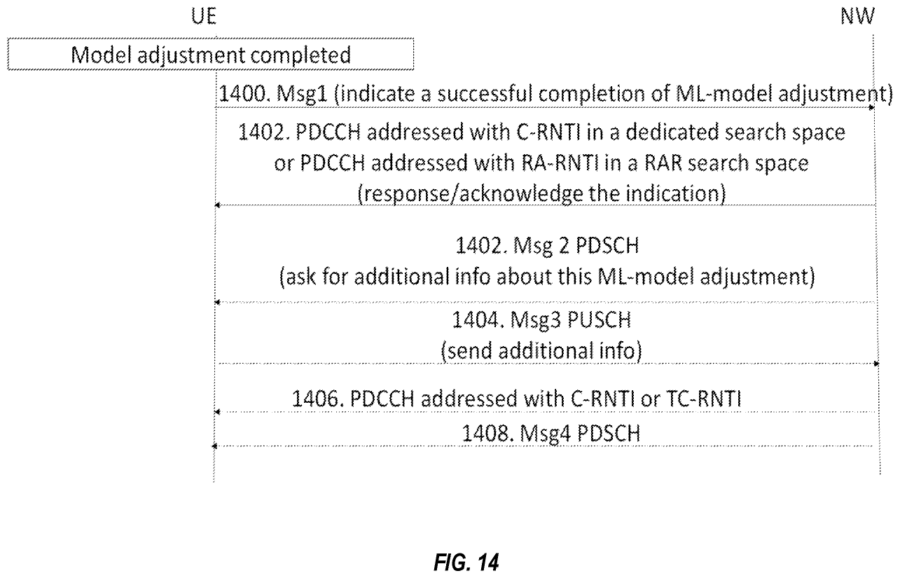

As illustrated in FIG. 14, after the ML-model(s) has/have been adjusted, the UE can initiate a random-access procedure to indicate to the network about its successful completion of its ML-model adjustment by transmitting a Msg1 or MsgA to the network (step 1400). If the UE did the ML-model adjustment in the RRC_IDLE or RRC_INACTIVE state, the random-access procedure can be the one that is used for the UE to transition from the RRC_IDLE or RRC_INACTIVE state to the RRC_CONNECTED state.

A dedicated set of RACH resources may or may not be configured for indicating a successful completion of the ML-model adjustment at the UE. If the UE adjusted the ML-model(s) in the RRC_CONNECTED state, a new triggering event can be defined for a UE to initiate a random-access procedure for indicating the success of ML-model adjustment.

Assume that a set of dedicated resources for Msg1/MsgA transmission (e.g., PRACH occasions, preamble indices) is configured for indicating a successful completion of ML-model adjustment. Then, after detecting this Msg1/MsgA from the UE, the network knows that the ML-model adjustment is completed at the UE side. The network responds to the indication by sending a PDCCH, which may or may not schedule a Msg2/MsgB PDSCH transmission (step 1402). The UE monitors this PDCCH within the RAR window and the PDSCH if scheduled. The UE assumes that the network has received its indication if it successfully detects the corresponding PDCCH and the corresponding info in the PDSCH if scheduled. The network may also ask for additional information from the UE about this ML-model adjustment (steps 1404 and 1406). The network may also adjust its behaviour or ML-model because of the UE ML-model update.

Thus, FIG. 14 illustrates an example of using random access procedure for enabling a UE to indicate a successful completion of its ML-model adjustment to the NW, assuming that a set of dedicated Msg1/MsgA resources is configured for this purpose. The dashed lines represent the optional signaling between the UE and the NW.

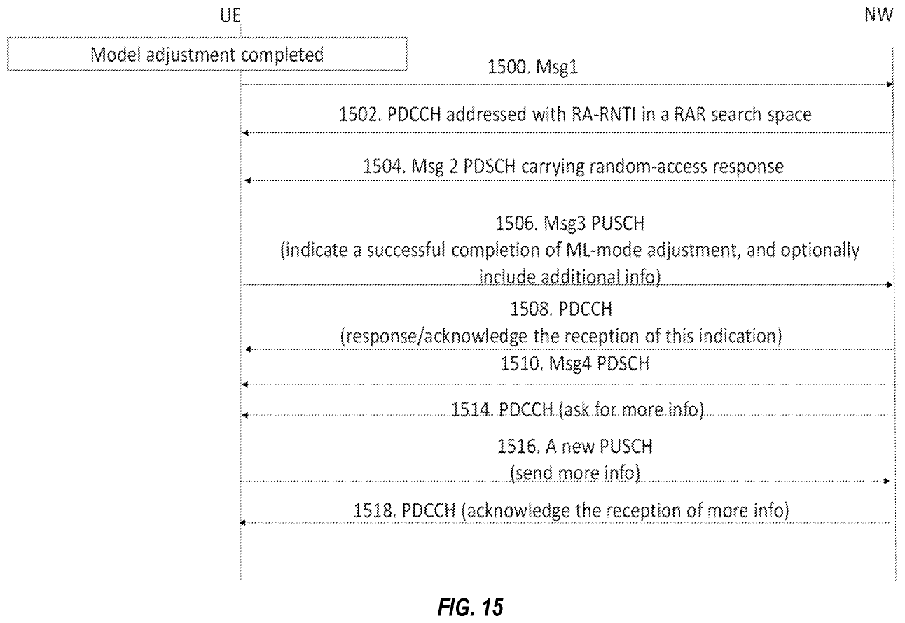

As illustrated in the example of FIG. 15, if no dedicated Msg1/MsgA resource (e.g., PRACH occasions, preamble indices) is configured for indicating a successful completion of a ML-model adjustment, then the UE transmits the indication of a successful completion of ML-model adjustment on the associated Msg3/MsgA PUSCH (step 1506). This can be enabled by e.g., defining a new RRC establishment cause or/and a new RRC resume cause for indicating the successful completing of ML-model adjustment, or adding new parameters in Msg3/MsgA for indicating the successful completing of ML-model adjustment. If the UE successfully detects the Msg4/MsgB, then it considers that the NW has received its indication.

Thus, FIG. 15 illustrates an example of using random access procedure for enabling a UE to indicate a successful completion of its ML-model adjustment to the NW, assuming no dedicated Msg1/MsgA resource is configured for this purpose. The dashed lines represent the optional signaling between the UE and the NW.

### 5. Further Description

Note that the methods described above, e.g., RRC message-based methods, MAC CE message based methods, UCI based methods, and random-access message based methods can be used in combination to support ML-model adjustment at the UE. For example, a UE in the RRC_CONNECTED state may use a UCI to request a ML-Model adjustment, Then, the UE goes to an RRC_INACTIVE state to adjust the model after receiving the response from the NW. After the ML-model adjustment is completed, the UE initiates a random-access procedure to transient from the RRC_INACTIVE state to RRC_CONNECTED state and at the same time indicating this successful ML-model adjustment to the NW.

Also note that even though the examples given in the present disclosure focus mainly on the signaling aspects over the Uu interface, the same methodologies can be applied for supporting Model update/adjustment using signaling between different UEs over the PC5 interface. In that case, sidelink related physical signals/channels and procedures can be utilized and enhanced to support the model update related signaling between UEs. Examples of these signals/channels/procedures include PC5 connection establishment procedure, sidelink control information (SCI), physical sidelink control channel (PSCCH), physical sidelink feedback channel (PSFCH).

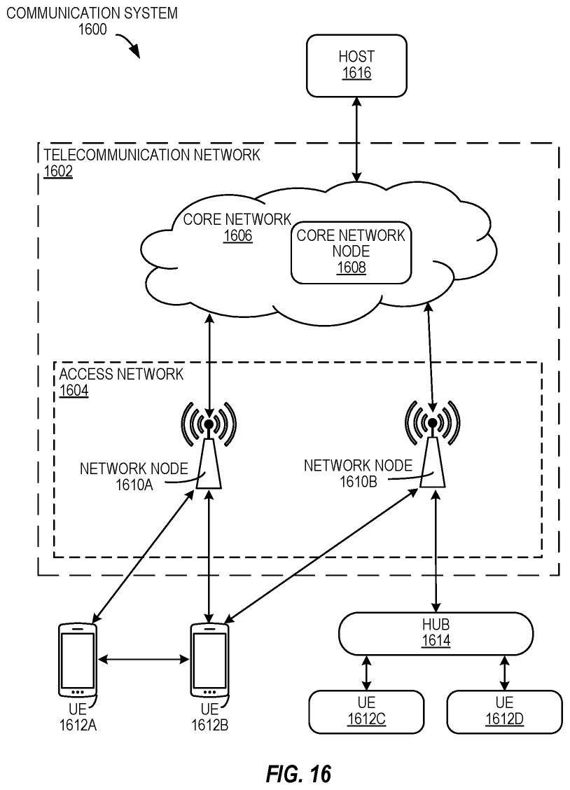

FIG. 16 shows an example of a communication system 1600 in which embodiments of the present disclosure may be implemented.

In the example, the communication system 1600 includes a telecommunication network 1602 that includes an access network 1604, such as a Radio Access Network (RAN), and a core network 1606, which includes one or more core network nodes 1608. The access network 1604 includes one or more access network nodes, such as network nodes 1610A and 1610B (one or more of which may be generally referred to as network nodes 1610), or any other similar Third Generation Partnership Project (3GPP) access node or non-3GPP Access Point (AP). The network nodes 1610 facilitate direct or indirect connection of User Equipment (UE), such as by connecting UEs 1612A, 1612B, 1612C, and 1612D (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system 1600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1602 is a cellular network that implements 3GPP standardized features. Accordingly, the telecommunication network 1602 may support network slicing to provide different logical networks to different devices that are connected to the telecommunication network 1602. For example, the telecommunication network 1602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1614 communicates with the access network 1604 to facilitate indirect communication between one or more UEs (e.g., UE 1612C and/or 1612D) and network nodes (e.g., network node 1610B). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a Virtual Reality (VR) headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610B. The hub 1614 may also allow for a different communication scheme and/or schedule between the hub 1614 and UEs (e.g., UE 1612C and/or 1612D), and between the hub 1614 and the core network 1606. In other examples, the hub 1614 is connected to the core network 1606 and/or one or more UEs via a wired connection. Moreover, the hub 1614 may be configured to connect to a Machine-to-Machine (M2M) service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub-that is, a hub whose primary function is to route communications to/from the UEs from/to the network node 1610B. In other embodiments, the hub 1614 may be a non-dedicated hub-that is, a device which is capable of operating to route communications between the UEs and the network node 1610B, but which is additionally capable of operating as a communication start and/or end point for certain data channels.

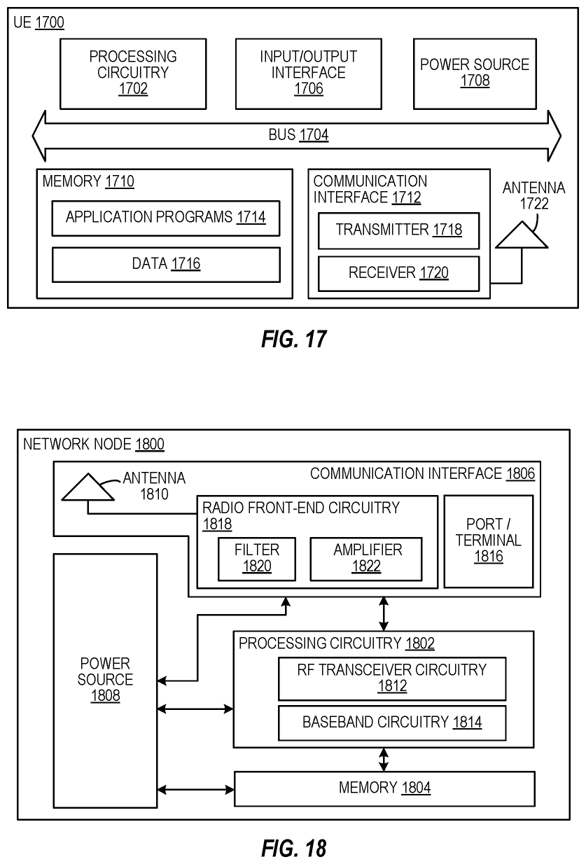

FIG. 17 shows a UE 1700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1702 may include multiple Central Processing Units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging the power source 1708. Power circuitry may perform any formatting, converting, or other modification to the power from the power source 1708 to make the power suitable for the respective components of the UE 1700 to which power is supplied.

The memory 1710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1710 may allow the UE 1700 to access instructions, application programs, and the like stored on transitory or non-transitory memory media, to off-load data, or to upload data. An article of manufacture, such as one utilizing a communication system, may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., the antenna 1722) and may share circuit components, software, or firmware, or alternatively be implemented separately.

In the illustrated embodiment, communication functions of the communication interface 1712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 18 shows a network node 1800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes processing circuitry 1802, memory 1804, a communication interface 1806, and a power source 1808. The network node 1800 may be composed of multiple physically separate components (e.g., a Node B component and an RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1800 may be configured to support multiple RATs. In such embodiments, some components may be duplicated (e.g., separate memory 1804 for different RATs) and some components may be reused (e.g., an antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1800.

The processing circuitry 1802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1800 components, such as the memory 1804, to provide network node 1800 functionality.

In some embodiments, the processing circuitry 1802 includes a System on a Chip (SOC). In some embodiments, the processing circuitry 1802 includes one or more of Radio Frequency (RF) transceiver circuitry 1812 and baseband processing circuitry 1814. In some embodiments, the RF transceiver circuitry 1812 and the baseband processing circuitry 1814 may be on separate chips (or sets of chips), boards, or units, such as radio units and digital units. In alternative embodiments, part or all of the RF transceiver circuitry 1812 and the baseband processing circuitry 1814 may be on the same chip or set of chips, boards, or units.

The memory 1804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and the memory 1804 are integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. The radio front-end circuitry 1818 comprises filters 1820 and amplifiers 1822. The radio front-end circuitry 1818 may be connected to the antenna 1810 and the processing circuitry 1802. The radio front-end circuitry 1818 may be configured to condition signals communicated between the antenna 1810 and the processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of the filters 1820 and/or the amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface 1806 may comprise different components and/or different combinations of components.

In certain alternative embodiments, the network node 1800 does not include separate radio front-end circuitry 1818; instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes the one or more ports or terminals 1816, the radio front-end circuitry 1818, and the RF transceiver circuitry 1812 as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, the communication interface 1806, and/or the processing circuitry 1802 may be configured to perform any receiving operations and/or certain obtaining operations described herein as being performed by the network node 1800. Any information, data, and/or signals may be received from a UE, another network node, and/or any other network equipment. Similarly, the antenna 1810, the communication interface 1806, and/or the processing circuitry 1802 may be configured to perform any transmitting operations described herein as being performed by the network node 1800. Any information, data, and/or signals may be transmitted to a UE, another network node, and/or any other network equipment.

The power source 1808 provides power to the various components of the network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid or an electricity outlet) via input circuitry or an interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

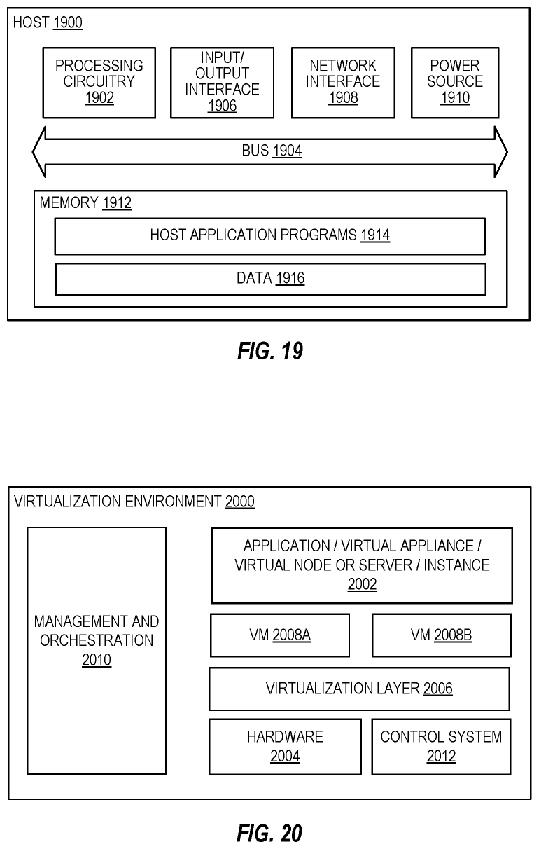

FIG. 19 is a block diagram of a host 1900, which may be an embodiment of the host 1616 of FIG. 16, in accordance with various aspects described herein. As used herein, the host 1900 may be or comprise various combinations of hardware and/or software including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and memory 1912. Other components may be included in other embodiments. Features of these components may be substantially similar to those described with respect to the devices of previous figures, such as FIGS. 17 and 18, such that the descriptions thereof are generally applicable to the corresponding components of the host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for Over-The-Top (OTT) services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or VM Monitors (VMMs)), provide VMs 2008A and 2008B (one or more of which may be generally referred to as VMs 2008), and/or perform any of the functions, features, and/or benefits described in relation with some embodiments described herein. The virtualization layer 2006 may present a virtual operating platform that appears like networking hardware to the VMs 2008.

The VMs 2008 comprise virtual processing, virtual memory, virtual networking, or interface and virtual storage, and may be run by a corresponding virtualization layer 2006. Different embodiments of the instance of a virtual appliance 2002 may be implemented on one or more of the VMs 2008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2008 may be a software implementation of a physical machine that runs programs as if they were executing on a physical, non-virtualized machine. Each of the VMs 2008, and that part of the hardware 2004 that executes that VM, be it hardware dedicated to that VM and/or hardware shared by that VM with others of the VMs 2008, forms separate virtual network elements. Still in the context of NFV, a virtual network function is responsible for handling specific network functions that run in one or more VMs 2008 on top of the hardware 2004 and corresponds to the application 2002.

The hardware 2004 may be implemented in a standalone network node with generic or specific components. The hardware 2004 may implement some functions via virtualization. Alternatively, the hardware 2004 may be part of a larger cluster of hardware (e.g., such as in a data center or CPE) where many hardware nodes work together and are managed via management and orchestration 2010, which, among others, oversees lifecycle management of the applications 2002. In some embodiments, the hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2012 which may alternatively be used for communication between hardware nodes and radio units.

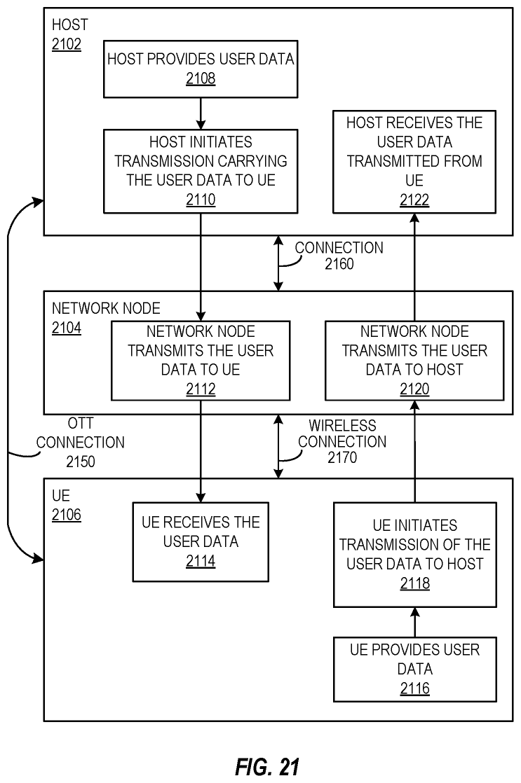

FIG. 21 shows a communication diagram of a host 2102 communicating via a network node 2104 with a UE 2106 over a partially wireless connection in accordance with some embodiments. Example implementations, in accordance with various embodiments, of the UE (such as the UE 1612A of FIG. 16 and/or the UE 1700 of FIG. 17), the network node (such as the network node 1610A of FIG. 16 and/or the network node 1800 of FIG. 18), and the host (such as the host 1616 of FIG. 16 and/or the host 1900 of FIG. 19) discussed in the preceding paragraphs will now be described with reference to FIG. 21.

Like the host 1900, embodiments of the host 2102 include hardware, such as a communication interface, processing circuitry, and memory. The host 2102 also includes software, which is stored in or is accessible by the host 2102 and executable by the processing circuitry. The software includes a host application that may be operable to provide a service to a remote user, such as the UE 2106 connecting via an OTT connection 2150 extending between the UE 2106 and the host 2102. In providing the service to the remote user, a host application may provide user data which is transmitted using the OTT connection 2150.

The network node 2104 includes hardware enabling it to communicate with the host 2102 and the UE 2106 via a connection 2160. The connection 2160 may be direct or pass through a core network (like the core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by the UE 2106 and executable by the UE's processing circuitry. The software includes a client application, such as a web browser or operator-specific “app” that may be operable to provide a service to a human or non-human user via the UE 2106 with the support of the host 2102. In the host 2102, an executing host application may communicate with the executing client application via the OTT connection 2150 terminating at the UE 2106 and the host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via the connection 2160 between the host 2102 and the network node 2104 and via a wireless connection 2170 between the network node 2104 and the UE 2106 to provide the connection between the host 2102 and the UE 2106. The connection 2160 and the wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104 in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR, or AR which it can broadcast, multicast, or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2150 between the host 2102 and the UE 2106 in response to variations in the measurement results. The measurement procedure and/or the network functionality for reconfiguring the OTT connection 2150 may be implemented in software and hardware of the host 2102 and/or the UE 2106. In some embodiments, sensors (not shown) may be deployed in or in association with other devices through which the OTT connection 2150 passes; the sensors may participate in the measurement procedure by supplying values of the monitored quantities exemplified above, or by supplying values of other physical quantities from which software may compute or estimate the monitored quantities. The reconfiguring of the OTT connection 2150 may include message format, retransmission settings, preferred routing, etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency, and the like by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality.

The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a first node, the method comprising: sending (300), to a second node, a first message that indicates a need or desire or preference to update or reconfigure a functionality in the first node related to a Machine Learning, ML, model (e.g., either the ML-model directly or a functionality of which the ML-model is a part).

Embodiment 2: The method of embodiment 1 wherein the first message is an RRC message, MAC CE, Msg1, MsgA, Msg3, a combination of Msg1 and Msg3, UCI, or SCI.

Embodiment 3: The method of embodiment 1 or 2 wherein the first message comprises: (a) request for a functionality update, (b) a functionality ID, (c) a functionality area ID characterizing the purpose of the functionality ID, e.g., channel estimation, decoding, etc., (d) an indication of whether the functionality can be updated in DRX, non-DRX, RRC_CONNECTED STATE, RRC_INACTIVE STATE or RRC_IDLE STATE, (e) time required to update the functionality, (f) a preferred functionality at the second node, (g) an indication that indicates to the second node that the first node needs to update an ML-model, wherein the indication is transmitted within the first message (e.g., the RRC message UEAssistanceInformation), (h) a combination of any two or more of (a)-(g).

Embodiment 4: The method of any of embodiments 1 to 3 further comprising receiving (302), from the second node, a second message responsive to the first message.

Embodiment 5: The method of embodiment 4 wherein the second message is an RRC message, MAC CE, Msg2, MsgB, Msg4, a PDCCH/PSCCH on a specific search space, a PDCCH/PSCCH addressed with a specific RNTI, a DCI format, or a SCI format.

Embodiment 6: The method of embodiment 4 wherein the second message comprises: (i) a functionality ID, (ii) a functionality area ID characterizing the purpose of the functionality ID, (iii) an indication of whether the functionality can be updated in DRX, non-DRX, RRC_CONNECTED STATE, RRC_INACTIVE STATE or RRC_IDLE STATE, (iv) a functionality executed at the second node, (v) whether the functionality of the first node is explicitly supported by the second node, (vi) request for the first node to transmit more information about the functionality update and the resources to use for such transmission, (vii) location/time to update the functionality, (viii) an indication that indicates that the first node is to transition to IDLE or INACTIVE state, upon which the first node is to update or reconfigure the functionality, or (ix) a combination of any two or more of (i)-(viii)

Embodiment 7: The method of any of embodiments 1 to 6 further comprising sending (304), to the second node, third message comprising an indication that the functionality related to the ML-model has been updated.

Embodiment 8: The method of embodiment 7 wherein the third message is an RRC message, MAC CE, Msg1, MsgA, Msg3, a combination of Msg1 and Msg3, UCI, or SCI.

Embodiment 9: The method of embodiment 7 or 8 wherein the third message further comprises: I. a functionality ID, II. a functionality area ID characterizing the technical functionality scope of the functionality, III. an indication on whether the functionality update is successfully completed, or IV. a combination of any two or more of I-III.

Embodiment 10: The method of any of embodiments 1 to 9 wherein the first message is a request message or an assistance information message.

Embodiment 11: The method of any of embodiments 1 to 10 wherein the functionality is the ML-model or a functionality configured that is implemented in part by the ML-model.

Embodiment 12: The method of any of embodiments 1 to 11 wherein the first node is a User Equipment, UE, and the second network node is a network node in a wireless network (e.g., a Radio Access Network (RAN) of a cellular communications system such as, e.g., a 5G or 6G system) or a second UE.

Embodiment 13: A method performed by a first node, the method comprising: performing an update of a functionality related to the ML-model (e.g., without first sending a request to a second node); and sending, to a second node, a message comprising an indication that the functionality related to the ML-model has been updated.

Embodiment 14: The method of embodiment 13 wherein the message is an RRC message, MAC CE, Msg1, MsgA, Msg3, a combination of Msg1 and Msg3, UCI, or SCI.

Embodiment 15: The method of embodiment 13 or 14 wherein the message further comprises: I. a functionality ID, II. a functionality area ID characterizing the technical functionality scope of the functionality, III. an indication on whether the functionality update is successfully completed, or IV. a combination of any two or more of I-III.

Embodiment 16: The method of any of embodiments 13 to 15 wherein the functionality is the ML-model or a functionality configured that is implemented in part by the ML-model.

Embodiment 17: The method of any of embodiments 13 to 16 wherein the first node is a User Equipment, UE, and the second network node is a network node in a wireless network (e.g., a Radio Access Network (RAN) of a cellular communications system such as, e.g., a 5G or 6G system) or a second UE.

Embodiment 18: The method of any of the previous embodiments, further comprising: providing user data; and forwarding the user data to a host via the transmission to the network node.

### Group B Embodiments

Embodiment 19: A method performed by a second node, the method comprising:
receiving (300), from a first node, a first message that indicates a need or desire to update or reconfigure a functionality related to a Machine Learning, ML, model (e.g., either the ML-model directly or a functionality of which the ML-model is a part).

Embodiment 20: The method of embodiment 19 wherein the first message is an RRC message, MAC CE, Msg1, MsgA, Msg3, a combination of Msg1 and Msg3, UCI, or SCI.

Embodiment 21: The method of embodiment 19 or 20 wherein the first message comprises: (a) request for a functionality update, (b) a functionality ID, (c) a functionality area ID characterizing the purpose of the functionality ID, e.g., channel estimation, decoding, etc., (d) an indication of whether the functionality can be updated in DRX, non-DRX, RRC_CONNECTED STATE, RRC_INACTIVE STATE or RRC_IDLE STATE, (e) time required to update the functionality, (f) a preferred functionality at the second node, (g) an indication that indicates to the second node that the first node needs to update an ML-model, wherein the indication is transmitted within the first message (e.g., the RRC message UEAssistanceInformation), (h) a combination of any two or more of (a)-(g).

Embodiment 22: The method of any of any of embodiments 19 to 21 further comprising sending (302), to the first node, a second message responsive to the first message.

Embodiment 23: The method of embodiment 22 wherein the second message is an RRC message, MAC CE, Msg2, MsgB, Msg4, a PDCCH/PSCCH on a specific search space, a PDCCH/PSCCH addressed with a specific RNTI, a DCI format, or a SCI format.

Embodiment 24: The method of embodiment 22 wherein the second message comprises: (i) a functionality ID, (ii) a functionality area ID characterizing the purpose of the functionality ID, (iii) an indication of whether the functionality can be updated in DRX, non-DRX, RRC_CONNECTED STATE, RRC_INACTIVE STATE or RRC_IDLE STATE, (iv) a functionality executed at the second node, (v) whether the functionality of the first node is explicitly supported by the second node, (vi) request for the first node to transmit more information about the functionality update and the resources to use for such transmission, (vii) location/time to update the functionality, (viii) an indication that indicates that the first node is to transition to IDLE or INACTIVE state, upon which the first node is to update or reconfigure the functionality, or (ix) a combination of any two or more of (i)-(viii).

Embodiment 25: The method of any of embodiments 19 to 24 further comprising receiving (304), from the first node, third message comprising an indication that the functionality related to the ML-model has been updated.

Embodiment 26: The method of embodiment 25 wherein the third message is an RRC message, MAC CE, Msg1, MsgA, Msg3, a combination of Msg1 and Msg3, UCI, or SCI.

Embodiment 27: The method of embodiment 25 or 26 wherein the third message further comprises: V. a functionality ID, VI. a functionality area ID characterizing the technical functionality scope of the functionality, VII. an indication on whether the functionality update is successfully completed, or VIII. a combination of any two or more of I-III.

Embodiment 28: The method of any of embodiments 19 to 27 wherein the first message is a request message or an assistance information message.

Embodiment 29: The method of any of embodiments 19 to 28 wherein the functionality is the ML-model or a functionality configured that is implemented in part by the ML-model.

Embodiment 30: The method of any of embodiments 19 to 29 wherein the first node is a User Equipment, UE, and the second network node is a network node in a wireless network (e.g., a Radio Access Network (RAN) of a cellular communications system such as, e.g., a 5G or 6G system).

Embodiment 31: The method of any of the previous embodiments, further comprising: obtaining user data; and forwarding the user data to a host or a user equipment.

### Group C Embodiments

Embodiment 32: A user equipment comprising: processing circuitry configured to perform any of the steps of any of the Group A embodiments; and power supply circuitry configured to supply power to the processing circuitry.

Embodiment 33: A network node comprising: processing circuitry configured to perform any of the steps of any of the Group B embodiments; power supply circuitry configured to supply power to the processing circuitry.

Embodiment 34: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 35: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 36: The host of the previous embodiment, wherein the cellular network further includes a network node configured to communicate with the UE to transmit the user data to the UE from the host.

Embodiment 37: The host of the previous 2 embodiments, wherein: the processing circuitry of the host is configured to execute a host application, thereby providing the user data; and the host application is configured to interact with a client application executing on the UE, the client application being associated with the host application.

Embodiment 38: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 39: The method of the previous embodiment, further comprising: at the host, executing a host application associated with a client application executing on the UE to receive the user data from the UE.

Embodiment 40: The method of the previous embodiment, further comprising: at the host, transmitting input data to the client application executing on the UE, the input data being provided by executing the host application, wherein the user data is provided by the client application in response to the input data from the host application.

Embodiment 41: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 42: The host of the previous embodiment, wherein the cellular network further includes a network node configured to communicate with the UE to transmit the user data from the UE to the host.

Embodiment 43: The host of the previous 2 embodiments, wherein: the processing circuitry of the host is configured to execute a host application, thereby providing the user data; and the host application is configured to interact with a client application executing on the UE, the client application being associated with the host application.

Embodiment 44: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 45: The method of the previous embodiment, further comprising: at the host, executing a host application associated with a client application executing on the UE to receive the user data from the UE.

Embodiment 46: The method of the previous embodiment, further comprising: at the host, transmitting input data to the client application executing on the UE, the input data being provided by executing the host application, wherein the user data is provided by the client application in response to the input data from the host application.

Embodiment 47: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 48: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 49: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 50: The method of the previous embodiment, further comprising, at the network node, transmitting the user data provided by the host for the UE.

Embodiment 51: The method of any of the previous 2 embodiments, wherein the user data is provided at the host by executing a host application that interacts with a client application executing on the UE, the client application being associated with the host application.

Embodiment 52: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 53: The communication system of the previous embodiment, further comprising: the network node; and/or the user equipment.

Embodiment 54: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 55: The host of the previous 2 embodiments, wherein: the processing circuitry of the host is configured to execute a host application, thereby providing the user data; and the host application is configured to interact with a client application executing on the UE, the client application being associated with the host application.

Embodiment 56: The host of the any of the previous 2 embodiments, wherein the initiating receipt of the user data comprises requesting the user data.

Embodiment 57: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 58: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a first node, the method comprising:
sending, to a second node, a first message that indicates a request to update or reconfigure a functionality in the first node related to a Machine Learning, ML, model, wherein the functionality of the ML-model has a feature version;
receiving, from the second node, a second message responsive to the first message; and
performing an update of the functionality related to the ML-model based on the second message, wherein performing the update results in a change in the feature version of the functionality of the ML-model.

2. The method of claim 1, wherein the first message comprises:
a Radio Resource Control, RRC, message;
a Medium Access Control, MAC, Control Element, CE;
a Msg1;
a MsgA;
a Msg3;
a combination of Msg1 and Msg3;
an Uplink Control Information, UCI; or
a Sidelink Control Information, SCI.

3. The method of claim 1, wherein the first message comprises:
(a) a request for a functionality update;
(b) a functionality ID;
(c) a functionality area ID characterizing a purpose of the functionality ID;
(d) an indication of whether the functionality can be updated in Discontinuous Reception, DRX, or non-DRX, or RRC_CONNECTED STATE, or RRC_INACTIVE STATE or RRC_IDLE STATE;
(e) a time required to update the functionality,
(f) a preferred functionality at the second node,
(g) an indication that indicates to the second node that the first node needs to update the ML-model, wherein the indication is transmitted within the first message;
(h) a combination of any two or more of (a)-(g).

4. The method of claim 1, wherein the second message comprises:
an RRC message;
a MAC CE;
a Msg2;
a MsgB;
a Msg4;
a Physical Downlink Control Channel, PDCCH, or Physical Sidelink Control Channel, PSCCH, on a specific search space;
a PDCCH or PSCCH addressed with a specific Radio Network Temporary Identifier, RNTI;
a Downlink Control Information, DCI, format; or
a Sidelink Control Information, SCI, format.

5. The method of claim 1, wherein the second message comprises:
(i) a functionality ID,
(ii) a functionality area ID characterizing the purpose of the functionality ID,
(iii) an indication of whether the functionality can be updated in DRX, non-DRX, RRC_CONNECTED STATE, RRC_INACTIVE STATE or RRC_IDLE STATE,
(iv) a functionality executed at the second node,
(v) another indication of whether the functionality of the first node is explicitly supported by the second node,
(vi) a request for the first node to transmit more information about the functionality update and resources to use for such transmission,
(vii) a location/time to update the functionality,
(viii) an indication that indicates that the first node is to transition to IDLE or INACTIVE state, upon which the first node is to update or reconfigure the functionality, or
(ix) a combination of any two or more of (i)-(viii).

6. The method of claim 1, further comprising:
sending, to the second node, a third message comprising an indication that the functionality related to the ML-model has been updated.

7. The method of claim 6, wherein the third message is an RRC message, a MAC CE, a Msg1, a MsgA, a Msg3, a combination of Msg1 and Msg3, a UCI, or an SCI.

8. The method of claim 6, wherein the third message further comprises:
(i) a functionality ID,
(ii) a functionality area ID characterizing the technical functionality scope of the functionality,
(iii) an indication on whether the functionality update is successfully completed, or
(iv) a combination of any two or more of (i)-(iii).

9. The method of claim 1, wherein the first message is a request message or an assistance information message.

10. The method of claim 1, wherein the functionality is the ML-model or a functionality configured that is implemented in part by the ML-model.

11. The method of claim 1, wherein the first node is a User Equipment, UE, and the second network node is a network node in a Radio Access Network (RAN) of a cellular communications system or a second UE.

12. A method performed by a first node, the method comprising:
performing an update of a functionality related to an ML-model without first sending a request to a second node, wherein the functionality of the ML-model has a feature version and performing the update results in a change in the feature version of the functionality of the ML model; and
sending, to the second node, a message comprising an indication that the functionality related to the ML-model has been updated.

13. The method of claim 12, wherein the message is an RRC message, a MAC CE message, a Msg1, a MsgA, a Msg3, a combination of Msg1 and Msg3, a UCI, or an SCI.

14. The method of claim 12, wherein the message further comprises:
(i) a functionality ID,
(ii) a functionality area ID characterizing the technical functionality scope of the functionality,
(iii) an indication on whether the functionality update is successfully completed, or
(iv) a combination of any two or more of (i)-(iii).

15. The method of claim 13, wherein the functionality is the ML-model or configured to be implemented in part by the ML-model.

16. The method of claim 12, wherein the first node is a UE, and the second network node is a network node in a wireless network comprising a RAN of a cellular communications system or a second UE.

17. A method performed by a second node, the method comprising:
receiving, from a first node, a first message that indicates a request to update or reconfigure a functionality related to a Machine Learning, ML, model, wherein the functionality of the ML model has a feature version; and
sending, to the first node, a second message responsive to the first message, wherein the first node performs an update to the functionality related to the ML-model based on the second message, wherein performing the update results in a change in the feature version of the functionality of the ML model.

18. The method of claim 17, wherein the first message comprises:
an RRC message,
a MAC CE message,
a Msg1,
a MsgA,
a Msg3,
a combination of Msg1 and Msg3,
a UCI, or
an SCI.

19. The method of claim 17, wherein the first message comprises:
(a) a request for a functionality update,
(b) a functionality ID,
(c) a functionality area ID characterizing the purpose of the functionality ID comprising a channel estimation or a decoding,
(d) an indication of whether the functionality can be updated in DRX, non-DRX, RRC_CONNECTED STATE, RRC_INACTIVE STATE or RRC_IDLE STATE,
(e) a time required to update the functionality,
(f) a preferred functionality at the second node,
(g) an indication that indicates to the second node that the first node needs to update an ML-model, wherein the indication is transmitted within the first message comprising an RRC UEAssistanceInformation message,
(h) a combination of any two or more of (a)-(g).

20. The method of claim 17, wherein the second message comprises:
an RRC message,
a MAC CE message,
a Msg2,
a MsgB,
a Msg4,
a Physical Downlink Control Channel, PDCCH/Physical Sidelink Control Channel, PSCCH, on a specific search space,
a PDCCH/PSCCH addressed with a specific Radio Network Temporary Identifier (RNTI),
a Downlink Control Information, DCI, format, or
a Sidelink Control Information, SCI, format.

21. The method of claim 17, wherein the second message comprises:
(i) a functionality ID,
(ii) a functionality area ID characterizing the purpose of the functionality ID,
(iii) an indication of whether the functionality can be updated in DRX, non-DRX, RRC_CONNECTED STATE, RRC_INACTIVE STATE or RRC_IDLE STATE,
(iv) a functionality executed at the second node,
(v) an indication whether the functionality of the first node is explicitly supported by the second node,
(vi) a request for the first node to transmit more information about the functionality update and the resources to use for such transmission,
(vii) a location/time to update the functionality,
(viii) an indication that indicates that the first node is to transition to IDLE or INACTIVE state, upon which the first node is to update or reconfigure the functionality, or
(ix) a combination of any two or more of (i)-(viii).

22. The method of claim 17, further comprising:
receiving, from the first node, third message comprising an indication that the functionality related to the ML-model has been updated.

23. The method of claim 22, wherein the third message is an RRC message, a MAC CE message, a Msg1, a MsgA, a Msg3, a combination of Msg1 and Msg3, a UCI, or an SCI.

24. The method of claim 22, wherein the third message further comprises:
(i) a functionality ID,
(ii) a functionality area ID characterizing the technical functionality scope of the functionality,
(iii) an indication on whether the functionality update is successfully completed, or
(iv) a combination of any two or more of (i)-(iii).

25-29. (canceled)

30. A first node apparatus comprising:
receiver circuitry; and
processing circuitry associated with the receiver circuitry, the processing circuitry configured to cause the first network node to at least:
send, to a second node, a first message that indicates a request to update or reconfigure a functionality in the first node related to a Machine Learning, ML, model, wherein the functionality of the ML model has a feature version;
receive, from the second node, a second message responsive to the first message; and
perform an update of the functionality related to the ML-model based on the second message, wherein performing the update results in a change in the feature version of the functionality of the ML model.

31. A first second node apparatus comprising:
receiver circuitry; and
processing circuitry associated with the receiver circuitry, the processing circuitry configured to cause the first network node to at least:
receive, from a first node, a first message that indicates a request to update or reconfigure a functionality related to a Machine Learning, ML, model or another functionality in which the ML-model is a part, wherein the functionality or the another functionality of the ML-model has a feature version; and
send, to the first node, a second message responsive to the first message, wherein the first node performs an update to the functionality related to the ML-model based on the second message, wherein performing the update results in a change in the feature version of the functionality or the another functionality of the ML-model.
